(19) United States
(12) Patent Application Publication
(10) Pub. No.: US 2009/0105235 A1
(43) Pub. Date: Apr. 23, 2009

(54) INSECTICIDAL COMPOSITIONS WITH IMPROVED EFFECT

(75) Inventors: Peter Jeschke, Bergisch Gladbach (DE); Ralf Nauen, Langenfeld (DE); Rolf Pontzen, Leichlingen (DE); Udo Reckmann, Koln (DE); Peter Marczok, Koln (DE); Reiner Fischer, Monheim (DE); Robert Velten, Langenfeld (DE); Christian Arnold, Langenfeld (DE); Erich Sanwald, Kiel (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Bayer CropScience AG, 40789 Monheim Am Rhein (DE)

(21) Appl. No.: 12/096,903

(22) PCT Filed: Nov. 30, 2006
(86) PCT No.: PCT/EP2006/011468

§ 371 Date: Oct. 24, 2008

(30) Foreign Application Priority Data
Dec. 13, 2005 (DE) 10 2005 059 468.9

(51) Int. Cl. A01N 43/08; A01N 43/78; A01N 43/40; A01N 43/88; A01P 7/04

(52) U.S. Cl. 514/229.2; 514/471; 514/365; 514/357; 514/318; 514/341; 514/336; 514/342

(57) ABSTRACT

The present invention relates to increasing the activity of crop protection compositions comprising inhibitors of the nicotinic acetylcholine receptor (for example neonicotinoids) through the addition of ammonium salts and/or phosphonium salts or through the addition of ammonium or phosphonium salts and penetrants, to the corresponding compositions, to processes for preparing them and to their use in crop protection.

The present invention relates to increasing the activity of crop protection compositions comprising inhibitors of the nicotinic acetylcholine receptor (for example neonicotinoids) through the addition of ammonium salts and/or phosphonium salts or through the addition of ammonium or phosphonium salts and penetrants, to the corresponding compositions, to processes for preparing them and to their use in crop protection.

All inhibitors according to the invention of the nicotinic acetylcholine receptor are already known as agents for controlling animal pests, in particular insects, and can be prepared by processes described in the prior art. The activity of these compounds is good; however, in particular at low application rates and concentrations, it is not always entirely satisfactory. Furthermore, the compatibility of these compounds with plants is not always sufficient. There was therefore a need for increasing the activity of the crop protection compositions comprising the compounds.

Neonicotinoids can be described by the formula (Ia)

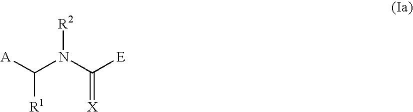

in which
A represents in each case optionally substituted cycloalkyl, heterocyclyl, aryl or hetaryl,
R¹ represents hydrogen or alkyl,
R² represents hydrogen or alkyl,
X represents ═N—NO₂, ═N—CN or ═CH—NO₂,
E represents methyl, OR³, SR³ or NR⁴R⁵,
in which
   R³ represents alkyl, alkenyl, cycloalkyl, cycloalkylalkyl, each of which is optionally substituted and optionally interrupted by one or more heteroatoms, or represents in each case substituted aryl, hetaryl, arylalkyl or hetarylalkyl,
   R⁴ and R⁵ independently of one another represent hydrogen, represent alkyl, alkenyl, alkynyl, cycloalkyl, cycloalkylalkyl, alkoxycarbonyl, each of which is optionally substituted and optionally interrupted by one or more heteroatoms, or represents in each optionally substituted aryl, hetaryl, arylalkyl or hetarylalkyl,
or
R² and R⁵ together with the nitrogen atom to which they are attached represent an optionally substituted ring which is optionally interrupted by one or more heteroatoms,
or
R² and R³ together with the atoms linking them form an optionally substituted ring which is optionally interrupted by one or more heteroatoms,
or
R² and R⁵ together with the atoms linking them form an optionally substituted ring which is optionally interrupted by one or more heteroatoms,
   (see, for example, EP-A 0 580 553, EP-A 0 376 279, EP-A 0 235 725, EP-A 0 375 907, EP-A 0 376 279, EP-A 0 425 978, EP-A 0 483 062, EP-A 0 649 845).

Neonicotinoids can be furthermore be described by the formula (Ib)

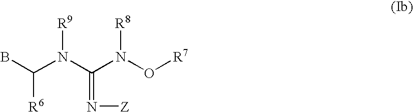

in which
B represents in each case optionally substituted aryl, hetaryl or heterocyclyl,
R⁶ and R⁸ represent hydrogen or alkyl,
R⁷ represents hydrogen or in each case optionally substituted alkyl, alkenyl, alkynyl, phenylalkyl or hetarylalkyl,
R⁹ represents hydrogen, alkyl or cycloalkyl,
Z represents cyano or nitro,
   (see, for example, EP-A 0 649 845 and WO 06/069 685).

Furthermore, neonicotinoids can be described by the formula (Ic)

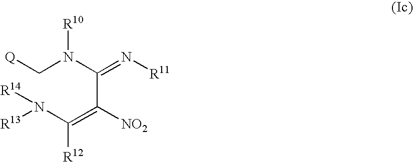

in which
Q represents a five- or six-membered carbocyclic or heterocyclic ring, for example phenyl, pyridyl, pyridazinyl, pyrimidinyl, pyrazinyl, pyrrolyl, pyrazolyl, imidazolyl, thienyl, furanyl, thiazolyl, isothiazolyl, oxazolyl and isoxazolyl or represents the reduced forms of the heterocyclic rings, such as tetrahydrofuranyl,
R¹⁰, R¹¹, R¹², R¹³ and R¹⁴ each independently of one another represent
   (a) branched or straight-chain C₁-C₁₀-alkyl, C₁-C₁₀-alkoxy, C₁-C₁₀-alkenyl, C₁-C₁₀-alkynyl, C₁-C₁₀-alkylthio, C₁-C₁₀-alkylsulphinyl, C₁-C₁₀-alkylsulphonyl, C₁-C₁₀-alkylcarbonyl, C₁-C₁₀-alkylcarbonothioyl, C₁-C₁₀-alkoxycarbonyl, C₁-C₁₀-alkylthiocarbonyl, C₁-C₁₀-alkoxycarbonothioyl, C₁-C₁₀-alkylthiocarbonothioyl or HC(═NH)—,
   (b) C₃-C₁₀-cycloalkyl or C₃-C₁₀-cycloalkenyl,
   (c) aryl, heterocyclyl, aryloxy, heterocyclyloxy, arylthio, heterocyclylthio, arylamino or heterocyclylamino,
   (d) hydrogen, hydroxyl, mercapto, amino, cyano, formyl, nitro, halogen or aminocarbonyl,
      (see, for example, WO 04/056178). Instead of each hydrogen atom present, each Q and each R¹⁰, R¹¹, R¹², R¹³ and R¹⁴ may carry one of the following substituents:
   (a) branched or straight-chain C₁-C₁₀-alkyl, C₁-C₁₀-alkoxy, C₁-C₁₀-alkenyl, C₁-C₁₀-alkynyl, C₁-C₁₀-alkylthio, C₁-C₁₀-alkylsulphinyl, C₁-C₁₀-alkylsulphonyl, C₁-C₁₀-alkylcarbonyl, C₁-C₁₀-alkylcarbonothioyl, C₁-C₁₀-alkoxycarbonyl, C₁-C₁₀-alkylthiocarbonyl, C₁-C₁₀-alkoxycarbonothioyl, C₁-C₁₀-alkylthiocarbonothioyl, C₁-C₁₀-dialkylphosphonyl, C₁-C₁₀-dialkylphosphatyl or HC(═NH)—,
   (b) C₃-C₁₀-cycloalkyl or C₃-C₁₀-cycloalkenyl,
   (c) aryl, heterocyclyl, aryloxy, heterocyclyloxy, arylthio, heterocyclylthio, arylamino or heterocyclylamino,
   (d) hydroxyl, mercapto, amino, cyano, formyl, nitro, halogen or aminocarbonyl,
      as long as these substituents are sterically compatible with one another and obey the rules of chemical valency and ring strain.

In addition, neonicotinoids can be described by the formula (Id)

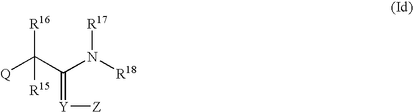

in which
Q is as defined above,
Z is as defined above,
Y represents N, CR¹⁹, COR¹⁹, CSOₙR¹⁹ (where n=0, 1 or 2), CN(R¹⁹)₂, C(C═O)R¹⁹, C(C═S)R¹⁹, C(C═NR¹⁹)R¹⁹, CP(═O)ₘ(R¹⁹)₂ (where m=0 or 1), CP(═S)ₘ(R¹⁹)₂ (where m=0 or 1),
   where each R¹⁹ independently of the others represents
   (a) branched or straight-chain C₁-C₁₀-alkyl, C₁-C₁₀-alkoxy, C₁-C₁₀-alkenyl, C₁-C₁₀-alkynyl, C₁-C₁₀-alkylthio, C₁-C₁₀-alkylsulphinyl, C₁-C₁₀-alkylsulphonyl, C₁-C₁₀-alkylcarbonyl, C₁-C₁₀-alkylcarbonothioyl, C₁-C₁₀-alkoxycarbonyl, C₁-C₁₀-alkylthiocarbonyl, C₁-C₁₀-alkoxycarbonothioyl, C₁-C₁₀-alkylthiocarbonothioyl, C₁-C₁₀-dialkylphosphonyl, C₁-C₁₀-dialkylphosphatyl or HC(═NH)—,
   (b) C₃-C₁₀-cycloalkyl or C₃-C₁₀-cycloalkenyl,
   (c) aryl, heterocyclyl, aryloxy, heterocyclyloxy, arylthio, heterocyclylthio, arylamino or heterocyclylamino,
   (d) hydrogen, hydroxyl, mercapto, amino, cyano, formyl, nitro, halogen or aminocarbonyl,
      R¹⁵ and R¹⁶ each independently of one another represent
   (a) branched or straight-chain C₁-C₁₀-alkyl, C₁-C₁₀-alkoxy, C₁-C₁₀-alkenyl, C₁-C₁₀-alkynyl, C₁-C₁₀-alkylthio, C₁-C₁₀-alkylsulphinyl, C₁-C₁₀-alkylsulphonyl, C₁-C₁₀-alkylcarbonyl, C₁-C₁₀-alkylcarbonothioyl, C₁-C₁₀-alkoxycarbonyl, C₁-C₁₀-alkylthiocarbonyl, C₁-C₁₀-alkoxycarbonothioyl, C₁-C₁₀-alkylthiocarbonothioyl, C₁-C₁₀-dialkylphosphonyl, C₁-C₁₀-dialkylphosphatyl or HC(═NH)—,
   (b) C₃-C₁₀-cycloalkyl or C₃-C₁₀-cycloalkenyl,
   (c) aryl, heterocyclyl, aryloxy, heterocyclyloxy, arylthio, heterocyclylthio, arylamino or heterocyclylamino,
   (d) hydrogen, hydroxyl, mercapto, amino, cyano, formyl, nitro, halogen or aminocarbonyl,
      R¹⁵ and R¹⁶ are attached to one another either directly or via a chain having a length of one to four atoms, where these atoms may be carbon, nitrogen, sulphur, phosphorus or oxygen,
      R¹⁷ and R¹⁸ each independently of one another represent
   (a) branched or straight-chain C₁-C₁₀-alkyl, C₁-C₁₀-alkoxy, C₁-C₁₀-alkenyl, C₁-C₁₀-alkynyl, C₁-C₁₀-alkylthio, C₁-C₁₀-alkylsulphinyl, C₁-C₁₀-alkylsulphonyl, C₁-C₁₀-alkylcarbonyl, C₁-C₁₀-alkylcarbonothioyl, C₁-C₁₀-alkoxycarbonyl, C₁-C₁₀-alkylthiocarbonyl, C₁-C₁₀-alkoxycarbonothioyl, C₁-C₁₀-alkylthiocarbonothioyl, C₁-C₁₀-dialkylphosphonyl, C₁-C₁₀-dialkylphosphatyl or HC(═NH)—,
   (b) C₃-C₁₀-cycloalkyl or C₃-C₁₀-cycloalkenyl,
   (c) aryl, heterocyclyl, aryloxy, heterocyclyloxy, arylthio, heterocyclylthio, arylamino or heterocyclylamino,
   (d) hydrogen, hydroxyl, mercapto, amino, cyano, formyl, nitro, halogen or aminocarbonyl,
      R¹⁷ and R¹⁸ are attached to one another either directly or via a chain having a length of one to four atoms, where these atoms may be carbon, nitrogen, sulphur, phosphorus or oxygen,
      R¹⁶ and R¹⁷ are attached to one another either directly or via a chain having a length of one to four atoms, where these atoms may be carbon, nitrogen, sulphur, phosphorus or oxygen,
      (see, for example, WO 04/057960). Instead of each hydrogen atom present, each Q, Y and each R¹⁵, R¹⁶, R¹⁷, R¹⁸ and R¹⁹ may carry one of the following substituents:
   (a) branched or straight-chain C₁-C₁₀-alkyl, C₁-C₁₀-alkoxy, C₁-C₁₀-alkenyl, C₁-C₁₀-alkynyl, C₁-C₁₀-alkylthio, C₁-C₁₀-alkylsulphinyl, C₁-C₁₀-alkylsulphonyl, C₁-C₁₀-alkylcarbonyl, C₁-C₁₀-alkylcarbonothioyl, C₁-C₁₀-alkoxycarbonyl, C₁-C₁₀-alkylthiocarbonyl, C₁-C₁₀-alkoxycarbonothioyl, C₁-C₁₀-alkylthiocarbonothioyl, C₁-C₁₀-dialkylphosphonyl, C₁-C₁₀-dialkylphosphatyl or HC(═NH)—,
   (b) C₃-C₁₀-cycloalkyl or C₃-C₁₀-cycloalkenyl,
   (c) aryl, heterocyclyl, aryloxy, heterocyclyloxy, arylthio, heterocyclylthio, arylamino or heterocyclylamino,
   (d) hydroxyl, mercapto, amino, cyano, formyl, nitro, halogen or aminocarbonyl,
      as long as these substituents are sterically compatible with one another and obey the rules of chemical valency and ring strain.

In addition, neonicotinoids can be described by the formula (Ie)

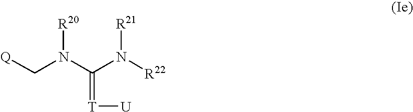

in which
Q is as defined above,
T-U represents C(CHO)—NO₂,
R²⁰, R²¹ and R²² each independently of one another represent
(a) branched or straight-chain C₁-C₁₀-alkyl, C₁-C₁₀-alkoxy, C₁-C₁₀-alkenyl, C₁-C₁₀-alkynyl, C₁-C₁₀-alkylthio, C₁-C₁₀-alkylsulphinyl, C₁-C₁₀-alkylsulphonyl, C₁-C₁₀-alkylcarbonyl, C₁-C₁₀-alkylcarbonothioyl, C₁-C₁₀-alkoxycarbonyl, C₁-C₁₀-alkylthiocarbonyl, C₁-C₁₀-alkoxycarbonothioyl, C₁-C₁₀-alkylthiocarbonothioyl, C₁-C₁₀-dialkylphosphonyl, C₁-C₁₀-dialkylphosphatyl or HC(═NH)—,
(b) C₃-C₁₀-cycloalkyl or C₃-C₁₀-cycloalkenyl,
(c) aryl, heterocyclyl, aryloxy, heterocyclyloxy, arylthio, heterocyclylthio, arylamino or heterocyclylamino,
(d) hydrogen, hydroxyl, mercapto, amino, cyano, formyl, nitro, halogen or aminocarbonyl,
   R²⁰ and R²¹ are attached to one another either directly or via a chain having a length of one to four atoms, where these atoms may be carbon, nitrogen, sulphur or oxygen,
   (see, for example, WO 04/058714). Instead of each hydrogen atom present, each Q and each R²⁰, R²¹ and R²² may carry one of the following substituents:
(a) branched or straight-chain C₁-C₁₀-alkyl, C₁-C₁₀-alkoxy, C₁-C₁₀-alkenyl, C₁-C₁₀-alkynyl, C₁-C₁₀-alkylthio, C₁-C₁₀-alkylsulphinyl, C₁-C₁₀-alkylsulphonyl, C₁-C₁₀-alkylcarbonyl, C₁-C₁₀-alkylcarbonothioyl, C₁-C₁₀-alkoxycarbonyl, C₁-C₁₀-alkylthiocarbonyl, C₁-C₁₀-alkoxycarbonothioyl, C₁-C₁₀-alkylthiocarbonothioyl, C₁-C₁₀-dialkylphosphonyl, C₁-C₁₀-dialkylphosphatyl or HC(═NH)—,
(b) C₃-C₁₀-cycloalkyl or C₃-C₁₀-cycloalkenyl,
(c) aryl, heterocyclyl, aryloxy, heterocyclyloxy, arylthio, heterocyclylthio, arylamino or heterocyclylamino,
(d) hydroxyl, mercapto, amino, cyano, formyl, nitro, halogen or aminocarbonyl,
   as long as these substituents are sterically compatible with one another and obey the rules of chemical valency and ring strain.

Furthermore, neonicotinoids can be described by the formula (If)

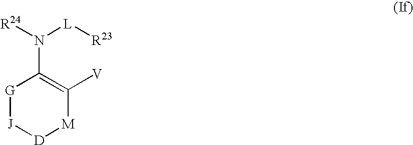

in which
R²³ represents an unsubstituted or substituted 5- or 6-membered aromatic heterocyclic radical which contains nitrogen,
R²⁴ represents hydrogen, in each case unsubstituted or substituted alkyl, alkenyl, cycloalkyl, cycloalkenyl, aryl, —O—R²⁵, —S—R²⁵, —SO—R²⁵, —SO₂—R²⁵, —CO—R²⁵ or CO₂—R²⁵,
R²⁵ represents hydrogen or in each case unsubstituted or substituted alkyl, alkenyl, alkynyl, cycloalkyl, cycloalkenyl or aryl,
G, J and D independently of one another each represent an unsubstituted or substituted carbon atom or heteroatom or represent a single bond,
L represents in each case unsubstituted or substituted alkylene or alkylidene,
M represents CO or CS,
V represents hydrogen or represents in each case unsubstituted or substituted alkyl, alkenyl, alkynyl or aryl or represents nitro, halogen or represents —W—R²⁶,
W represents CO, CO₂ or S(O)ₘ,
m represents 0, 1 or 2 and
R²⁶ represents in each case unsubstituted or substituted alkyl, alkenyl, alkynyl, cycloalkyl, cycloalkenyl or aryl,
   (see, for example, EP-A 0 539 588 and WO 06/037 475).

Furthermore, neonicotinoids can be described by the formula (Ig)

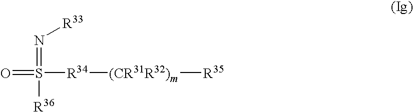

in which
m represents an integer from 0 to 3,
R³¹ and R³² independently of one another represent hydrogen, methyl, ethyl, fluorine, chlorine or bromine,
R³³ represents nitro, cyano or COOR³⁷,
R³⁴ represents a single bond or R³⁶, S and R³⁴ together represent a five- or six-membered ring,
R³⁵ represents 6-halopyridin-3-yl, 6-(C₁-C₄)-alkylpyridin-3-yl, 6-(C₁-C₄)-alkoxypyridin-3-yl, 2-chlorothiazol-4-yl or 3-chloroisoxazol-5-yl if m=0-3 and R³⁴ is a single bond or represents hydrogen, C₁-C₄-alkyl, phenyl, 6-halopyridin-3-yl, 6-(C₁-C₄)-alkylpyridin-3-yl, 6-(C₁-C₄)-alkoxypyridin-3-yl, 2-chlorothiazol-4-yl or 3-chloroisoxazol-5-yl if m=0-1 and R³⁶, S and R³⁴ together form a five- or six-membered ring,
R³⁶ represents methyl or ethyl and
R³⁷ represents C₁-C₃-alkyl,

### (see WO 06/60029).

Further inhibitors of the nicotinic acetylcholine receptor are taught in WO 05/055715. They are described by the formula (Ih)

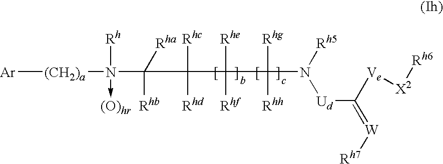

in which
a and hr independently of one another are 0 or 1,
Ar is selected from the group consisting of

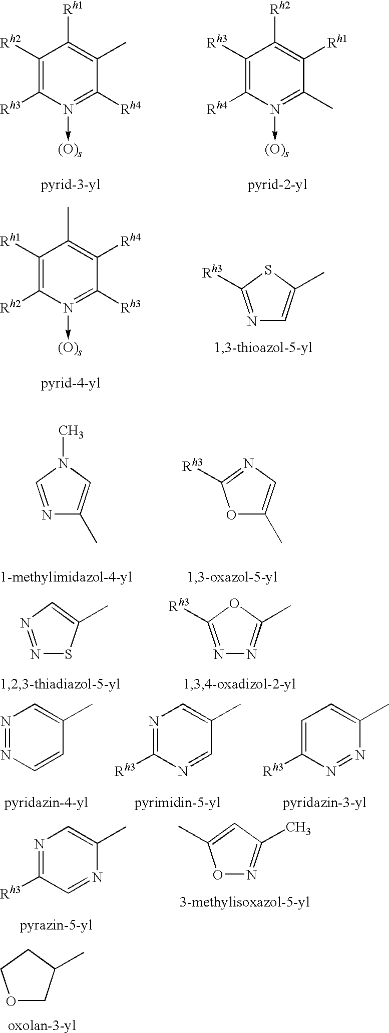

where
   R^{h1}, R^{h2}, R^{h3} and R^{h4} independently of one another are selected from the group consisting of hydrogen, halogen, alkyl, alkoxy, haloalkyl and haloalkoxy,
   s is 0 or 1,
R^{ha}, R^{hb}, R^{hc} and R^{hd} independently of one another are selected from the group consisting of hydrogen and alkyl,
b and c are 0 or 1 and,
if b and c are 1,
R^{he}, R^{hf}, R^{hg} and R^{hh} independently of one another are selected from the group consisting of hydrogen and alkyl,
R^{h} is selected from the group consisting of hydrogen, haloalkyl, alkoxyalkyl, alkoxyalkoxyalkyl, cycloalkylalkyl, cyanoalkyl, formyl, alkylcarbonyl, alkoxycarbonyl, alkylsulphonyl, dialkylphosphonato, oxolan-3-ylmethyl, 2H-3,4,5,6-tetrahydropyran-2-ylmethyl, cyclohex-1-en-3-yl, thien-3-ylmethyl, furan-2-ylmethyl, furan-3-ylmethyl, benzo[b]furan-2-ylmethyl, 2-R^{h8}-1,3-thiazol-4-ylmethyl, 5-R^{h8}-1,2,4-oxadiazol-3-ylmethyl,

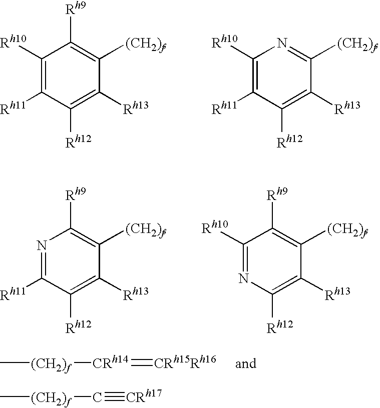

in which
R^{h8} is selected from the group consisting of halogen, alkyl, aryl and hetaryl, where aryl and hetaryl are optionally substituted by at least one substituent selected from the group consisting of halogen, alkyl, haloalkyl, alkoxy and haloalkoxy;
f is 1 or 2 and
R^{h9}, R^{h10}, R^{h11}, R^{h12} and R^{h13} independently of one another are selected from the group consisting of hydrogen, halogen, alkyl, haloalkyl, alkoxy, haloalkoxy, alkoxyiminoalkyl, cyano, nitro, 2-alkyl-2H-tetrazol-5-yl, aryl and aryloxy;
R^{h14}, R^{h15} and R^{h16} independently of one another are selected from the group consisting of hydrogen, halogen, alkyl and aryl;
R^{h17} is selected from the group consisting of hydrogen, alkyl,

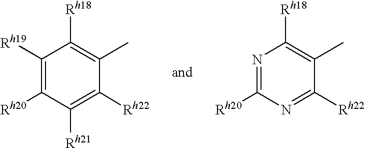

in which
R¹⁸, R^{h19}, R^{h20}, R^{h21} and R^{h22} independently of one another are selected from the group consisting of hydrogen, halogen, alkyl, haloalkyl, alkoxy and haloalkoxy,
R^{h5} is selected from the group consisting of hydrogen, alkyl and

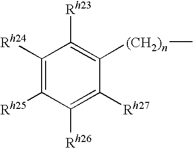

in which
n is 1 or 2,
R^{h23}, R^{h24}, R^{h25}, R^{h26} and R^{h27} independently of one another are selected from the group consisting of hydrogen, halogen, alkyl, haloalkyl, alkoxy and haloalkoxy,
d and e independently of one another are 0 or 1 and,
if d and 1 are 1, U and V are methylene,
R^{h6} is selected from the group consisting of hydrogen, alkyl, cycloalkyl, cycloalkylalkyl, alkoxy, alkoxyalkyl, alkoxyalkoxyalkyl, alkenyl, haloalkenyl and

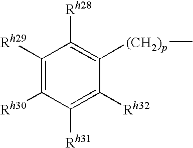

in which
p is 1 or 2 and
R^{h28}, R^{h29}, R^{h30}, R^{h31} and R^{h32} independently of one another are selected from the group consisting of hydrogen, halogen, alkyl, haloalkyl, alkoxy and haloalkoxy,
R^{h7} is selected from the group consisting of cyano and nitro,
W is selected from the group consisting of —CR^{h33}— and —N—,
X² is selected from the group consisting of —CR^{h34}R^{h35}—, —O—, —S— and —NR^{h36}—,
   where
   R^{h33}, R^{h34}, R^{h35} and R^{h36} independently of one another are selected from the group consisting of hydrogen and alkyl,
   with the proviso that
   if Ar is oxolan-3-yl; a, b and c are 1; R^{ha} up to and including R^{hg} are hydrogen; d, e and r are 0; R is —(CH₂)ₘCR^{h14}=CR^{h15}R^{h16} or —(CH₂)ₘC≡CR^{h17}; R^{h5} is hydrogen or alkyl; R^{h6} is hydrogen, alkyl, alkenyl or haloalkenyl and W is —CH—, then X² is not —S—,
   if b and c are 0,
      R^{h} and R^{h5} together are ethylene, forming a piperazine ring,
   if d and e are 0,
      R^{h5} and X² together may form a cycle —CH₂(CH₂)_{q}— or —CH₂YCH₂—, where q is 1 or 2, Y is selected from the group consisting of O, S and NR^{h37}, where R^{h37} is hydrogen or alkyl, and
      X² is selected from the group consisting of —CH—, —O—, —S— and —N—, where, if X is —CH— or —N—, R^{h6} is selected from the group consisting of hydrogen, alkyl and the definitions of R^{h} mentioned above.

Preferred substituents or ranges of the radicals listed in the formulae (Ia) to (Ih) mentioned above and below are illustrated below.

Preferred ranges for the radicals listed in formula (Ia) are given below:
A preferably represents optionally halogen- (fluorine-, chlorine-, bromine-, iodine-), cyano-, nitro-, C₁-C₄-alkyl-, C₁-C₄-haloalkyl-, C₁-C₄-alkoxy- or C₁-C₄-haloalkoxy-substituted phenyl.
A preferably represents tetrahydrofuryl which is optionally substituted by halogen, C₁-C₃-alkyl or C₁-C₃-haloalkyl.
A furthermore preferably represents pyrazolyl, 1,2,4-triazolyl, oxazolyl, isoxazolyl, thiazolyl, isothiazolyl, 1,2,5-thiadiazolyl, pyridyl, pyrazinyl or pyrimidinyl which are optionally substituted by fluorine, chlorine, bromine, iodine, cyano, nitro, C₁-C₂-alkyl (which is optionally substituted by fluorine and/or chlorine), C₁-C₂-alkoxy (which is optionally substituted by fluorine and/or chlorine), C₁-C₂-alkyl (which is optionally substituted by fluorine and/or chlorine), C₁-C₂-alkylthio (which is optionally substituted by fluorine and/or chlorine), C₁-C₂-alkylsulphonyl (which is optionally substituted by fluorine and/or chlorine).
A furthermore preferably represents an optionally halogen- or C₁-C₃-alkyl-substituted saturated C₅-C₆-cycloalkyl radical in which optionally one methylene group is replaced by O or S.
A particularly preferably represents thiazolyl or pyridyl which are optionally substituted by halogen (in particular chlorine) or C₁-C₃-alkyl (in particular methyl).
A furthermore particularly preferably represents an optionally halogen- (in particular chlorine-) or C₁-C₃-alkyl- (in particular methyl-)substituted tetrahydrofuran radical.
A very particularly preferably represents one of the radicals

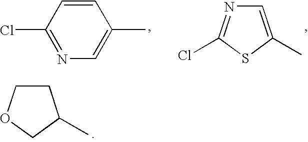

A especially preferably represents 2-chloropyrid-5-yl

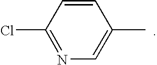

A furthermore especially preferably represents 2-chloro-1,3-thiazol-5-yl

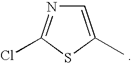

A furthermore especially preferably represents

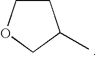

R¹ preferably represents hydrogen, methyl, ethyl, n-propyl or isopropyl.
R¹ particularly preferably represents hydrogen or methyl.
R² preferably represents hydrogen, methyl, ethyl, n-propyl or isopropyl.
R² particularly preferably represents hydrogen, methyl or ethyl.
R³ preferably represents straight-chain or branched C₁-C₆-alkyl, C₃-C₆-alkenyl, C₃-C₇-cycloalkyl, C₃-C₇-cycloalkyl-C₁-C₂-alkyl, each of which is optionally interrupted by oxygen or sulphur and optionally substituted by halogen, hydroxyl or cyano, represents optionally C₁-C₄-alkyl-, C₁-C₂-haloalkyl-, halogen-, C₁-C₄-alkoxy-, C₁-C₂-haloalkoxy-, nitro- or cyano-substituted phenyl-C₁-C₂-alkyl, phenyl, pyridyl, thiazolyl, pyrazolyl or pyrimidyl.
R³ particularly preferably represents straight-chain or branched C₁-C₄-alkyl, in particular methyl, ethyl, propyl, isopropyl, sec-butyl, tert-butyl, hydroxy-C₁-C₄-alkyl, in particular 2-hydroxyethyl, 3-hydroxypropyl, C₃-C₄-alkenyl, in particular 2-propenyl, 2-butenyl, C₅-C₇-cycloalkyl, in particular cyclopropylmethyl, optionally fluorine-, chlorine-, bromine-, C₁-C₄-alkyl-, C₁-C₄-alkoxy-, C₁-C₂-haloalkyl-, C₁-C₂-haloalkoxy-, nitro- or cyano-substituted phenyl or benzyl.
R³ very particularly preferably represents methyl or phenyl.
R⁴ and R⁵ preferably and independently of one another represent hydrogen, straight-chain or branched C₁-C₆-alkyl, C₃-C₆-alkenyl, C₃-C₆-alkynyl, C₃-C₇-cycloalkyl, C₃-C₇-cycloalkyl-C₁-C₆-alkenyl, C₁-C₆-alkoxycarbonyl, each of which is optionally interrupted by oxygen or sulphur and each of which is optionally substituted by halogen, or represent optionally C₁-C₄-alkyl-, C₁-C₂-haloalkyl- or halogen-substituted phenyl, phenyl-C₁-C₂-alkenyl, pyridyl, thiazolyl, pyridyl-C₁-C₂-alkenyl or thiazolyl-C₁-C₂-alkenyl.
R⁴ and R⁵ particularly preferably and independently of one another represent hydrogen, straight-chain or branched C₁-C₄-alkyl, C₁-C₄-haloalkyl or C₃-C₄-alkenyl.
R⁴ and R⁵ very particularly preferably and independently of one another represent hydrogen, methyl, ethyl, propyl, isopropyl, trifluoroethyl, 1,1,1-trifluoroisopropyl, 2-propenyl or 2-butenyl.
R⁴ and R⁵ especially preferably and independently of one another represent hydrogen, methyl or ethyl.
X preferably represents ═N—NO₂, ═N—CN, ═CH—NO₂ or ═C(CHO)NO₂.
X particularly preferably represents ═N—NO₂, ═N—CN, ═CH—NO₂.
E preferably represents OR³, SR³ or NR⁴R⁵.
E particularly preferably represents SR³ or NR⁴R⁵.
R² and R³ preferably represent an optionally C₁-C₄-alkyl-substituted C₂-C₄-alkylidenediyl group which may optionally be interrupted by a heteroatom from the group consisting of oxygen, sulphur and nitrogen.
R² and R³ particularly preferably represent a C₂-C₃-alkylidenediyl group which may optionally be interrupted by a heteroatom from the group consisting of oxygen, sulphur and nitrogen.
R² and R³ very particularly preferably represent —CH₂—CH₂—, —CH₂—CH₂—CH₂—, —CH₂—O—CH₂—, —CH₂—S—CH₂—, —CH₂—NH—CH₂ or —CH₂—N(CH₃)—CH₂—.
R⁴ and R⁵ preferably and together with the nitrogen atom to which they are attached represent a 4-, 5-, 6- or 7-membered ring or represent a 7- to 10-membered bicycle which are optionally also interrupted by oxygen, sulphur, sulphoxyl, sulphonyl, carbonyl, N—R⁶ or by quaternized nitrogen and are optionally substituted by C₁-C₄-alkyl.
R⁴ and R⁵ particularly preferably represent optionally methyl- or ethyl-substituted C₄-C₆-alkylidenediyl which is optionally interrupted by oxygen, sulphur or N—R⁶.
R⁴ and R⁵ very particularly preferably together with the nitrogen atom to which they are attached represent optionally methyl- or ethyl-substituted pyrrolidino, morpholino, thiomorpholino, piperidino, imidazolo or piperazino.
R² and R⁵ preferably together with the atoms linking them represent an optionally C₁-C₄-alkyl-substituted saturated 5-, 6- or 7-membered ring.
R² and R⁵ particularly preferably together with the atoms linking them represent a saturated 5-, 6- or 7-membered ring.
R² and R⁵ very particularly preferably and together with the atoms linking them represent a saturated 5- or 6-membered ring.

In a group of outstanding compounds, R¹ represents hydrogen.

Preferred substituents or ranges of the radicals listed in formula (Ib) mentioned above and below are given below.
B preferably represents optionally halogen-, cyano-, nitro-, C₁-C₄-alkyl-, C₁-C₄-haloalkyl-, C₁-C₄-alkoxy- or C₁-C₄-haloalkoxy-substituted phenyl.
B also preferably represents pyrazolyl, 1,2,4-triazolyl, oxazolyl, isoxazolyl, thiazolyl, isothiazolyl, 1,2,5-thiadiazolyl, pyridyl, pyrazinyl, pyrimidinyl, C₁-C₄-alkyl-substituted tetrahydrofuryl which are optionally substituted by fluorine, chlorine, bromine, cyano, nitro, C₁-C₄-alkyl (which is optionally substituted by fluorine and/or chlorine), C₁-C₄-alkylthio (which is optionally substituted by fluorine and/or chlorine), C₁-C₄-alkylsulphonyl (which is optionally substituted by fluorine and/or chlorine).
B particularly preferably represents thiazolyl or pyridyl which are optionally substituted by halogen or C₁-C₃-alkyl.
B very particularly preferably represents thiazolyl or pyridyl which are optionally substituted by chlorine or methyl.
B especially preferably represents 2-chloropyrid-5-yl or 2-chloro-1,3-thiazol-5-yl.
R⁶ preferably represents hydrogen or methyl, ethyl or n-propyl or isopropyl.
R⁶ particularly preferably represents hydrogen or methyl.
R⁶ very particularly preferably represents hydrogen.
R⁷ preferably represents hydrogen, methyl, ethyl, n-propyl or n-butyl.
R⁷ particularly preferably represents hydrogen, methyl, ethyl or n-propyl.
R⁷ very particularly preferably represents methyl.
R⁸ particularly represents hydrogen, methyl or ethyl.
R⁸ particularly preferably represents hydrogen.
R⁹ preferably represents hydrogen, methyl, ethyl, n-propyl, isopropyl, cyclopropyl, cyclobutyl, cyclopentyl or cyclohexyl.
R⁹ particularly preferably represents hydrogen, methyl, ethyl or cyclopropyl.
R⁹ very particularly preferably represents hydrogen.
Z preferably represents cyano or nitro.

In an outstanding group of compounds of the formula (Ib), B represents

2-chloropyrid-5-yl

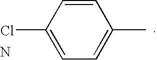

In a further outstanding group of compounds of the formula (Ib),

B represents
2-chloro-1,3-thiazol-5-yl

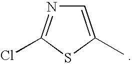

The general or preferred radical definitions or illustrations given above apply to the end products and, correspondingly, to the starting materials and intermediates. These radical definitions can be combined with one another as desired, i.e. including combinations between the respective preferred ranges.

Preference according to the invention is given to compounds of the formulae (Ia) to (Ih) which contain a combination of the meanings given above as being preferred.

Particular preference according to the invention is given to compounds of the formulae (Ia) to (Ih) which contain a combination of the meanings given above as being particularly preferred.

Very particular preference according to the invention is given to compounds of the formulae (Ia) to (Ih) which contain a combination of the meanings given above as being very particularly preferred.

In the radical definitions given above and below, hydrocarbon radicals, such as alkyl, are in each case straight-chain or branched as far as this is possible—including in combination with heteroatoms, such as alkoxy.

Specific mention may be made of the following compounds of the general formula (Ia) from the class of the neonicotinoids:
Compound (Ia-1), thiamethoxam, has the formula

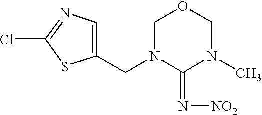

and is known from EP-A 0 580 553.
Compound (Ia-2), clothianidin, has the formula

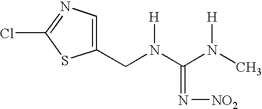

and is known from EP-A 0 376 279.
Compound (Ia-3), thiacloprid, has the formula

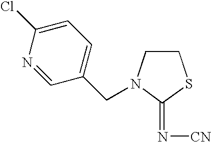

and is known from EP-A 0 235 725.
Compound (Ia-4), dinotefuran, has the formula

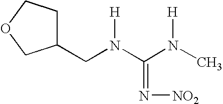

and is known from EP-A 0 649 845.
Compound (Ia-5), acetamiprid, has the formula

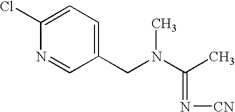

and is known from WO 91/04965.
Compound (Ia-6), nitenpyram, has the formula

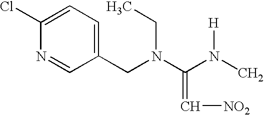

and is known from EP-A 0 302 389.
Compound (Ia-7), imidacloprid, has the formula

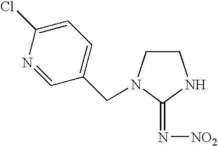

and is known from EP-A 0 192 060.
Compound (Ia-8), imidaclothiz, has the formula

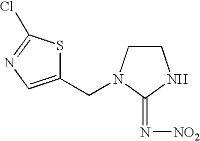

Compound (Ia-9), AKD-1022, has the formula

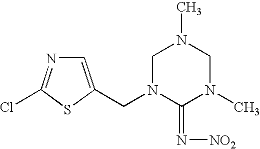

and is known from EP 428941 A1.

Furthermore, mention may be made of the following compounds of the general formula (Ib) from the class of the neonicotinoids:
Compound (Ib-1) has the formula

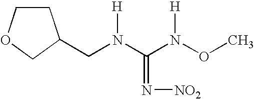

and is known from EP-A 0 649 845.
Compound (Ib-2) has the formula

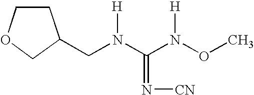

and is known from WO 2006 069 685 A1.
Compound (Ib-3) has the formula

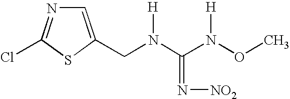

and is known from WO 2006 069 685 A1.

Furthermore, mention may be made of the following compounds of the general formula (Ic) from the class of the neonicotinoids:
Compound (Ic-1) has the formula

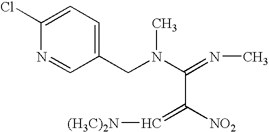

and is known from WO 04/056178.

Furthermore, mention may be made of the following compounds of the general formula (Id) from the class of the neonicotinoids:
Compound (Id-1) has the formula

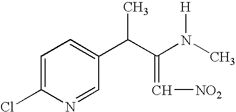

and is known from WO 04/057960.
Compound (Id-2) has the formula

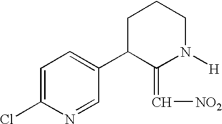

and is known from WO 04/057960.

Furthermore, mention may be made of the following compounds of the general formula (Ie) from the class of the neonicotinoids, which may also be present as geometrical isomers (A/B):
Compound (Ie-1) has the formula

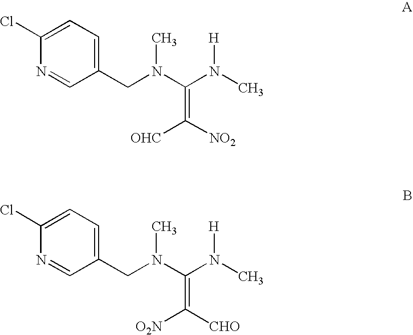

and is known from WO 04/058714.
Compound (Ie-2) has the formula

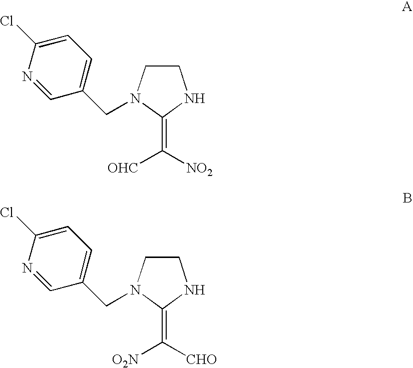

and is known from WO 04/058714.

Furthermore, mention may be made of the following compounds of the general formula (If):
Compound (If-1) has the formula

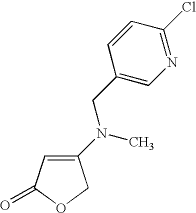

and is known from WO 92/00964 and WO 06/037475.
Compound (If-2) has the formula

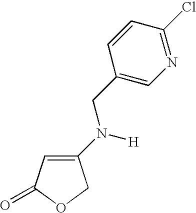

and is known from WO 92/00964 and WO 06/037475.

Furthermore, mention may be made of the following compounds of the general formula (Ig):
Compound (Ig-1) has the formula

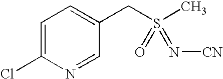

and is known from US 2005 0 228 027 A1.
Compound (Ig-2) has the formula

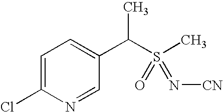

and is known from US 2005 0 228 027 A1.
Compound (Ig-3) has the formula

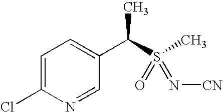

and is known from US 2005 0 228 027 A1.
Compound (Ig-4) has the formula

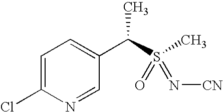

and is known from US 2005 0 228 027 A1.
Compound (Ig-5) has the formula

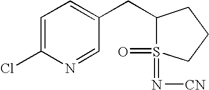

and is known from US 2005 0 228 027 A1.

Furthermore, mention may be made of the following compounds of the general formula (Ih) from the class of the neonicotinoids

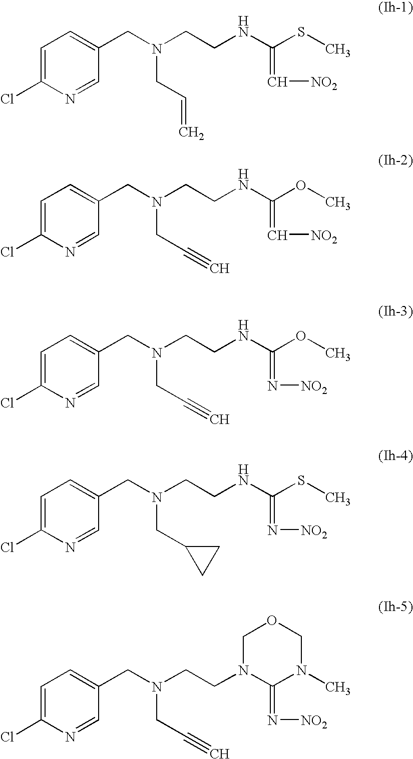

Inhibitors of the nicotinic acetylcholine receptor have broad insecticidal activity; however, in specific cases the activity is unsatisfactory.

The active compounds in the compositions according to the invention can be used in a broad concentration range. Here, the concentration of the active compounds in the formulation is usually 0.1-50% by weight.

Descriptions have already been given in the literature to the effect that the activity of various active compounds can be increased through addition of ammonium or phosphonium salts. The salts in question, however, are salts with a detergent effect (for example WO 95/017817) and/or salts having relatively long alkyl and/or aryl substituents, which have a permeabilizing effect or which increase the solubility of the active compound (for example EP-A 0 453 086, EP-A 0 664 081, FR-A 2 600 494, U.S. Pat. No. 4,844,734, U.S. Pat. No. 5,462,912, U.S. Pat. No. 5,538,937, US-A 03/0224939, US-A 05/0009880, US-A 05/0096386). Furthermore, the prior art describes the activity only for certain active compounds and/or certain applications of the composition in question. In still other cases, they are salts of sulphonic acids where the acids for their part have a paralysing action on insects (U.S. Pat. No. 2,842,476). An activity increase through ammonium sulphate is described for the herbicides glyphosate and phosphinothricin (U.S. Pat. No. 6,645,914, EP-A 0 036 106). However, this prior art neither discloses nor suggests a corresponding activity for insecticides.

Also, the use of ammonium sulphate as a formulating auxiliary has been described for certain active compounds and applications (WO 92/16108), but it is used there for the purpose of stabilizing the formulation, not for increasing activity.

It has now been found, entirely surprisingly, that the activity of insecticides which are inhibitors of the nicotinic acetylcholine receptor can be increased significantly through the addition of ammonium salts and/or phosphonium salts to the as-used solution (tank mix application) or through the incorporation of these salts into a formulation comprising such insecticides. Accordingly, the present invention provides the use of ammonium salts and/or phosphonium salts for increasing the activity of crop protection compositions comprising insecticidally active inhibitors of the nicotinic acetylcholine receptor as active compound. The invention also provides compositions comprising such insecticides and activity-increasing ammonium salts and/or phosphonium salts, specifically including not only formulated active compounds but also ready-to-use compositions (spray liquors). Finally, the invention also provides the use of these compositions for controlling harmful insects.

Ammonium salts and phosphonium salts which, according to the invention, increase the activity of crop protection compositions comprising inhibitors of the nicotinic acetylcholine receptor are defined by formula (II)

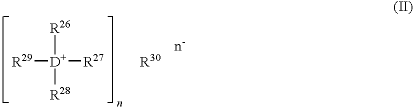

in which
D represents nitrogen or phosphorus,
D preferably represents nitrogen,
R²⁶, R²⁷, R²⁸ and R²⁹ independently of one another represent hydrogen or in each case optionally substituted C₁-C₈-alkyl or mono- or polyunsaturated, optionally substituted C₁-C₈-alkylene, where the substituents may be selected from the group consisting of halogen, nitro and cyano,
R²⁶, R²⁷, R²⁸ and R²⁹ preferably independently of one another represent hydrogen or in each case optionally substituted C₁-C₄-alkyl, where the substituents may be selected from the group consisting of halogen, nitro and cyano,
R²⁶, R²⁷, R²⁸ and R²⁹ particularly preferably independently of one another represent hydrogen, methyl, ethyl, n-propyl, isopropyl, n-butyl, isobutyl, s-butyl or t-butyl,
R²⁶, R²⁷, R²⁸ and R²⁹ very particularly preferably represent hydrogen,
R²⁶, R²⁷, R²⁸ and R²⁹ furthermore very particularly preferably both represent methyl or both represent ethyl,
n represents 1, 2, 3 or 4,
n preferably represents 1 or 2,
R³⁰ represents an inorganic or organic anion,
R³⁰ preferably represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate,
R³⁰ furthermore preferably represents carbonate, pentaborate, sulphite, benzoate, hydrogenoxalate, hydrogencitrate, methylsulphate or tetrafluoroborate,
R³⁰ particularly preferably represents lactate, sulphate, nitrate, thiosulphate, thiocyanate, citrate, oxalate or formate,
R³⁰ furthermore particularly preferably represents monohydrogenphosphate or dihydrogenphosphate and
R³⁰ very particularly preferably represents sulphate.

The ammonium salts and phosphonium salts of the formula (II) can be used in a broad concentration range to increase the activity of crop protection compositions comprising insecticidally or acaracidally active compounds. In general, the ammonium salts or phosphonium salts are used in the ready-to-use crop protection composition in a concentration of from 0.5 to 80 mmol/l, preferably from 0.75 to 37.5 mmol/l, particularly preferably from 1.5 to 25 mmol/l. In the case of a formulated product, the ammonium salt concentration and/or phosphonium salt concentration in the formulation is chosen such that it is within these stated general, preferred or very preferred ranges after the formulation has been diluted to the desired active compound concentration. The concentration of the salt in the formulation here is typically 1-50% by weight.

In a preferred embodiment of the invention, the activity is increased by adding to the crop protection compositions not only an ammonium salt and/or phosphonium salt but also, additionally, a penetrant. It is considered entirely surprising that even in these cases an even greater activity increase is observed. The present invention therefore likewise provides the use of a combination of penetrant and ammonium salts and/or phosphonium salts for increasing the activity of crop protection compositions comprising insecticidally active inhibitors of the nicotinic acetylcholine receptor as active compound. The invention likewise provides compositions which comprise insecticidally active inhibitors of the nicotinic acetylcholine receptor, penetrants and ammonium salts and/or phosphonium salts, including specifically not only formulated active compounds but also ready-to-use compositions (spray liquors). The invention additionally provides, finally, for the use of these compositions for controlling harmful insects.

Suitable penetrants in the present context include all those substances which are typically used to enhance the penetration of agrochemically active compounds into plants. Penetrants are defined in this context by their ability to penetrate from the aqueous spray liquor and/or from the spray coating into the cuticle of the plant and thereby to increase the mobility of active compounds in the cuticle. The method described in the literature (Baur et al., 1997, Pesticide Science 51, 131-152) can be used in order to determine this property.

Suitable penetrants are, for example, alkanol alkoxylates. Penetrants according to the invention are alkanol alkoxylates of the formula

R—O—(-AO)ᵥ—R′ (III)

in which
R represents straight-chain or branched alkyl having 4 to 20 carbon atoms,
R′ represents hydrogen, methyl, ethyl, n-propyl, isopropyl, n-butyl, isobutyl, t-butyl, n-pentyl or n-hexyl,
AO represents an ethylene oxide radical, a propylene oxide radical, a butylene oxide radical or represents mixtures of ethylene oxide and propylene oxide radicals or butylene oxide radicals and
v represents numbers from 2 to 30.

A preferred group of penetrants are alkanol alkoxylates of the formula

R—O—(-EO—)ₙ—R′ (III-a)

in which
R is as defined above,
R′ is as defined above,
EO represents —CH₂—CH₂—O— and
n represents numbers from 2 to 20.

A further preferred group of penetrants are alkanol alkoxylates of the formula

R—O—(-EO—)ₚ—(—PO—)_{q}—R′ (III-b)

in which
R is as defined above,
R′ is as defined above,
EO represents —CH₂—CH₂—O—,
PO represents

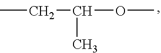

p represents numbers from 1 to 10 and
q represents numbers from 1 to 10.

A further preferred group of penetrants are alkanol alkoxylates of the formula

R—O—(—PO—)ᵣ-(EO—)ₛ—R′ (III-c)

in which
R is as defined above,
R′ is as defined above,
EO represents —CH₂—CH₂—O—,
PO represents

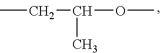

r represents numbers from 1 to 10 and
s represents numbers from 1 to 10.

A further preferred group of penetrants are alkanol alkoxylates of the formula

R—O—(-EO—)ₚ—(—BO—)_{q}—R′ (III-d)

in which
R and R′ are as defined above,
EO represents CH₂—CH₂—O—,
BO represents

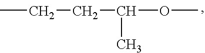

p represents numbers from 1 to 10 and
q represents numbers from 1 to 10.

A further preferred group of penetrants are alkanol alkoxylates of the formula

R—O—(—BO—)ᵣ—(-EO—)ₛ—R′ (III-e)

in which
R and R′ are as defined above,
BO represents

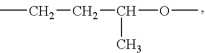

EO represents CH₂—CH₂—O—,
r represents numbers from 1 to 10 and
s represents numbers from 1 to 10.

A further preferred group of penetrants are alkanol alkoxylates of the formula

CH₃—(CH₂)ₜ—CH₂—O—(—CH₂—CH₂—O—)ᵤ—R′ (III-f)

in which
R′ is as defined above,
t represents numbers from 8 to 13 and
u represents numbers from 6 to 17.

In the formulae given above,
R preferably represents butyl, isobutyl, n-pentyl, isopentyl, neopentyl, n-hexyl, isohexyl, n-octyl, isooctyl, 2-ethylhexyl, nonyl, isononyl, decyl, n-dodecyl, isododecyl, lauryl, myristyl, isotridecyl, trimethylnonyl, palmityl, stearyl or eicosyl.

An example which may be mentioned of an alkanol alkoxylate of the formula (III-c) is 2-ethyl-hexyl alkoxylate of the formula

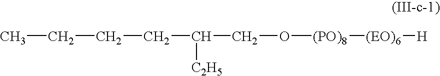

in which
EO represents —CH₂—CH₂—O—,
PO represents

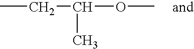

the numbers 8 and 6 are average values.

An example which may be mentioned of an alkanol alkoxylate of the formula (III-d) is the formula

CH₃—(CH₂)₁₀—O—(-EO—)₆—(—BO—)₂—CH₃ (III-d-1)

in which
EO represents CH₂—CH₂—O—,
BO represents

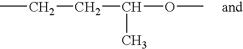

the numbers 10, 6 and 2 are average values.

Particularly preferred alkanol alkoxylates of the formula (III-f) are compounds of this formula in which
t represents numbers from 9 to 12 and
u represents numbers from 7 to 9.

The alkanol alkoxylate of the formula (III-f-1)

CH₃—(CH₂)ₜ—CH₂—O—(—CH₂—CH₂—O—)ᵤ—H (III-f-1)

in which
t represents the average value 10.5 and
u represents the average value 8.4
   may be mentioned as being very particularly preferred.

The above formulae provide a general definition of the alkanol alkoxylates. These substances are mixtures of substances of the stated type with different chain lengths. The indices therefore have average values which may also deviate from whole numbers.

The alkanol alkoxylates of the formulae stated are known and in some cases are available commercially or can be prepared by known methods (cf. WO 98-35 553, WO 00-35 278 and EP-A 0 681 865).

Suitable penetrants also include, for example, substances which promote the solubility of the compounds of the formula (I) in a spray coating. These include, for example, mineral and vegetable oils. Suitable oils are all mineral or vegetable oils—modified or otherwise—which can typically be used in agrochemical compositions. Mention may be made by way of example of sunflower oil, rapeseed oil, olive oil, castor oil, colza oil, maizeseed oil, cottonseed oil and soybean oil, or the esters of said oils. Preference is given to rapeseed oil, sunflower oil and their methyl or ethyl esters.

The concentration of penetrants in the compositions according to the invention can be varied within a wide range. In the case of a formulated crop protection composition, it is generally from 1 to 95% by weight, preferably from 1 to 55% by weight, particularly preferably from 15 to 40% by weight. In the ready-to-use compositions (spray liquors), the concentration is generally between 0.1 and 10 g/l, preferably between 0.5 and 5 g/l.

Inventively emphasized combinations of active compound, salt and penetrant are listed in the table below. Here, “penetrant as per test” means that any compound that acts as a penetrant in the cuticle penetration test (Baur et al., 1997, Pesticide Science 51, 131-152) is suitable.

| # | Active compound | Salt | Penetrant |
|---|---|---|---|
| 1 | thiamethoxam (Ia-1) | ammonium sulphate | as per test |
| 2 | thiamethoxam (Ia- | ammonium lactate | as per test |
| | 1) | | |
| 3 | thiamethoxam (Ia- | ammonium nitrate | as per test |
| | 1) | | |
| 4 | thiamethoxam (Ia- | ammonium thiosulphate | as per test |
| | 1) | | |
| 5 | thiamethoxam (Ia- | ammonium thiocyanate | as per test |
| | 1) | | |
| 6 | thiamethoxam (Ia- | ammonium citrate | as per test |
| | 1) | | |
| 7 | thiamethoxam (Ia- | ammonium oxalate | as per test |
| | 1) | | |
| 8 | thiamethoxam (Ia- | ammonium formate | as per test |
| | 1) | | |
| 9 | thiamethoxam (Ia- | ammonium hydrogenphosphate | as per test |
| | 1) | | |
| 10 | thiamethoxam (Ia- | ammonium dihydrogenphosphate | as per test |
| | 1) | | |
| 11 | thiamethoxam (Ia- | ammonium carbonate | as per test |
| | 1) | | |
| 12 | thiamethoxam (Ia- | ammonium benzoate | as per test |
| | 1) | | |
| 13 | thiamethoxam (Ia- | ammonium sulphite | as per test |
| | 1) | | |
| 14 | thiamethoxam (Ia- | ammonium benzoate | as per test |
| | 1) | | |
| 15 | thiamethoxam (Ia- | ammonium hydrogenoxalate | as per test |
| | 1) | | |
| 16 | thiamethoxam (Ia- | ammonium hydrogencitrate | as per test |
| | 1) | | |
| 17 | thiamethoxam (Ia- | ammonium acetate | as per test |
| | 1) | | |
| 18 | thiamethoxam (Ia- | tetramethylammonium sulphate | as per test |
| | 1) | | |
| 19 | thiamethoxam (Ia- | tetramethylammonium lactate | as per test |
| | 1) | | |
| 20 | thiamethoxam (Ia- | tetramethylammonium nitrate | as per test |
| | 1) | | |
| 21 | thiamethoxam (Ia- | tetramethylammonium thiosulphate | as per test |
| | 1) | | |
| 22 | thiamethoxam (Ia- | tetramethylammonium thiocyanate | as per test |
| | 1) | | |
| 23 | thiamethoxam (Ia- | tetramethylammonium citrate | as per test |
| | 1) | | |
| 24 | thiamethoxam (Ia- | tetramethylammonium oxalate | as per test |
| | 1) | | |
| 25 | thiamethoxam (Ia- | tetramethylammonium formate | as per test |
| | 1) | | |
| 26 | thiamethoxam (Ia- | tetramethylammonium hydrogenphosphate | as per test |
| | 1) | | |
| 27 | thiamethoxam (Ia- | tetramethylammonium dihydrogenphosphate | as per test |
| | 1) | | |
| 28 | thiamethoxam (Ia- | tetraethylammonium sulphate | as per test |
| | 1) | | |
| 29 | thiamethoxam (Ia- | tetraethylammonium lactate | as per test |
| | 1) | | |
| 30 | thiamethoxam (Ia- | tetraethylammonium nitrate | as per test |
| | 1) | | |
| 31 | thiamethoxam (Ia- | tetraethylammonium thiosulphate | as per test |
| | 1) | | |
| 32 | thiamethoxam (Ia- | tetraethylammonium thiocyanate | as per test |
| | 1) | | |
| 33 | thiamethoxam (Ia- | tetraethylammonium citrate | as per test |
| | 1) | | |
| 34 | thiamethoxam (Ia- | tetraethylammonium oxalate | as per test |
| | 1) | | |
| 35 | thiamethoxam (Ia- | tetraethylammonium formate | as per test |
| | 1) | | |
| 36 | thiamethoxam (Ia- | tetraethylammonium hydrogenphosphate | as per test |
| | 1) | | |
| 37 | thiamethoxam (Ia- | tetraethylammonium dihydrogenphosphate | as per test |
| | 1) | | |
| 38 | clothianidin (Ia-2) | ammonium sulphate | as per test |
| 39 | clothianidin (Ia-2) | ammonium lactate | as per test |
| 40 | clothianidin (Ia-2) | ammonium nitrate | as per test |
| 41 | clothianidin (Ia-2) | ammonium thiosulphate | as per test |
| 42 | clothianidin (Ia-2) | ammonium thiocyanate | as per test |
| 43 | clothianidin (Ia-2) | ammonium citrate | as per test |
| 44 | clothianidin (Ia-2) | ammonium oxalate | as per test |
| 45 | clothianidin (Ia-2) | ammonium formate | as per test |
| 46 | clothianidin (Ia-2) | ammonium hydrogenphosphate | as per test |
| 47 | clothianidin (Ia-2) | ammonium dihydrogenphosphate | as per test |
| 48 | clothianidin (Ia-2) | ammonium carbonate | as per test |
| 49 | clothianidin (Ia-2) | ammonium benzoate | as per test |
| 50 | clothianidin (Ia-2) | ammonium sulphite | as per test |
| 51 | clothianidin (Ia-2) | ammonium benzoate | as per test |
| 52 | clothianidin (Ia-2) | ammonium hydrogenoxalate | as per test |
| 53 | clothianidin (Ia-2) | ammonium hydrogencitrate | as per test |
| 54 | clothianidin (Ia-2) | ammonium acetate | as per test |
| 55 | clothianidin (Ia-2) | tetramethylammonium sulphate | as per test |
| 56 | clothianidin (Ia-2) | tetramethylammonium lactate | as per test |
| 57 | clothianidin (Ia-2) | tetramethylammonium nitrate | as per test |
| 58 | clothianidin (Ia-2) | tetramethylammonium thiosulphate | as per test |
| 59 | clothianidin (Ia-2) | tetramethylammonium thiocyanate | as per test |
| 60 | clothianidin (Ia-2) | tetramethylammonium citrate | as per test |
| 61 | clothianidin (Ia-2) | tetramethylammonium oxalate | as per test |
| 62 | clothianidin (Ia-2) | tetramethylammonium formate | as per test |
| 63 | clothianidin (Ia-2) | tetramethylammonium hydrogenphosphate | as per test |
| 64 | clothianidin (Ia-2) | tetramethylammonium dihydrogenphosphate | as per test |
| 65 | clothianidin (Ia-2) | tetraethylammonium sulphate | as per test |
| 66 | clothianidin (Ia-2) | tetraethylammonium lactate | as per test |
| 67 | clothianidin (Ia-2) | tetraethylammonium nitrate | as per test |
| 68 | clothianidin (Ia-2) | tetraethylammonium thiosulphate | as per test |
| 69 | clothianidin (Ia-2) | tetraethylammonium thiocyanate | as per test |
| 70 | clothianidin (Ia-2) | tetraethylammonium citrate | as per test |
| 71 | clothianidin (Ia-2) | tetraethylammonium oxalate | as per test |
| 72 | clothianidin (Ia-2) | tetraethylammonium formate | as per test |
| 73 | clothianidin (Ia-2) | tetraethylammonium hydrogenphosphate | as per test |
| 74 | clothianidin (Ia-2) | tetraethylammonium dihydrogenphosphate | as per test |
| 75 | thiacloprid (Ia-3) | ammonium sulphate | as per test |
| 76 | thiacloprid (Ia-3) | ammonium lactate | as per test |
| 77 | thiacloprid (Ia-3) | ammonium nitrate | as per test |
| 78 | thiacloprid (Ia-3) | ammonium thiosulphate | as per test |
| 79 | thiacloprid (Ia-3) | ammonium thiocyanate | as per test |
| 80 | thiacloprid (Ia-3) | ammonium citrate | as per test |
| 81 | thiacloprid (Ia-3) | ammonium oxalate | as per test |
| 82 | thiacloprid (Ia-3) | ammonium formate | as per test |
| 83 | thiacloprid (Ia-3) | ammonium hydrogenphosphate | as per test |
| 84 | thiacloprid (Ia-3) | ammonium dihydrogenphosphate | as per test |
| 85 | thiacloprid (Ia-3) | ammonium carbonate | as per test |
| 86 | thiacloprid (Ia-3) | ammonium benzoate | as per test |
| 87 | thiacloprid (Ia-3) | ammonium sulphite | as per test |
| 88 | thiacloprid (Ia-3) | ammonium benzoate | as per test |
| 89 | thiacloprid (Ia-3) | ammonium hydrogenoxalate | as per test |
| 90 | thiacloprid (Ia-3) | ammonium hydrogencitrate | as per test |
| 91 | thiacloprid (Ia-3) | ammonium acetate | as per test |
| 92 | thiacloprid (Ia-3) | tetramethylammonium sulphate | as per test |
| 93 | thiacloprid (Ia-3) | tetramethylammonium lactate | as per test |
| 94 | thiacloprid (Ia-3) | tetramethylammonium nitrate | as per test |
| 95 | thiacloprid (Ia-3) | tetramethylammonium thiosulphate | as per test |
| 96 | thiacloprid (Ia-3) | tetramethylammonium thiocyanate | as per test |
| 97 | thiacloprid (Ia-3) | tetramethylammonium citrate | as per test |
| 98 | thiacloprid (Ia-3) | tetramethylammonium oxalate | as per test |
| 99 | thiacloprid (Ia-3) | tetramethylammonium formate | as per test |
| 100 | thiacloprid (Ia-3) | tetramethylammonium hydrogenphosphate | as per test |
| 101 | thiacloprid (Ia-3) | tetramethylammonium dihydrogenphosphate | as per test |
| 102 | thiacloprid (Ia-3) | tetraethylammonium sulphate | as per test |
| 103 | thiacloprid (Ia-3) | tetraethylammonium lactate | as per test |
| 104 | thiacloprid (Ia-3) | tetraethylammonium nitrate | as per test |
| 105 | thiacloprid (Ia-3) | tetraethylammonium thiosulphate | as per test |
| 106 | thiacloprid (Ia-3) | tetraethylammonium thiocyanate | as per test |
| 107 | thiacloprid (Ia-3) | tetraethylammonium citrate | as per test |
| 108 | thiacloprid (Ia-3) | tetraethylammonium oxalate | as per test |
| 109 | thiacloprid (Ia-3) | tetraethylammonium formate | as per test |
| 110 | thiacloprid (Ia-3) | tetraethylammonium hydrogenphosphate | as per test |
| 111 | thiacloprid (Ia-3) | tetraethylammonium dihydrogenphosphate | as per test |
| 112 | dinetofuran (Ia-4) | ammonium sulphate | as per test |
| 113 | dinetofuran (Ia-4) | ammonium lactate | as per test |
| 114 | dinetofuran (Ia-4) | ammonium nitrate | as per test |
| 115 | dinetofuran (Ia-4) | ammonium thiosulphate | as per test |
| 116 | dinetofuran (Ia-4) | ammonium thiocyanate | as per test |
| 117 | dinetofuran (Ia-4) | ammonium citrate | as per test |
| 118 | dinetofuran (Ia-4) | ammonium oxalate | as per test |
| 119 | dinetofuran (Ia-4) | ammonium formate | as per test |
| 120 | dinetofuran (Ia-4) | ammonium hydrogenphosphate | as per test |
| 121 | dinetofuran (Ia-4) | ammonium dihydrogenphosphate | as per test |
| 122 | dinetofuran (Ia-4) | ammonium carbonate | as per test |
| 123 | dinetofuran (Ia-4) | ammonium benzoate | as per test |
| 124 | dinetofuran (Ia-4) | ammonium sulphite | as per test |
| 125 | dinetofuran (Ia-4) | ammonium benzoate | as per test |
| 126 | dinetofuran (Ia-4) | ammonium hydrogenoxalate | as per test |
| 127 | dinetofuran (Ia-4) | ammonium hydrogencitrate | as per test |
| 128 | dinetofuran (Ia-4) | ammonium acetate | as per test |
| 129 | dinetofuran (Ia-4) | tetramethylammonium sulphate | as per test |
| 130 | dinetofuran (Ia-4) | tetramethylammonium lactate | as per test |
| 131 | dinetofuran (Ia-4) | tetramethylammonium nitrate | as per test |
| 132 | dinetofuran (Ia-4) | tetramethylammonium thiosulphate | as per test |
| 133 | dinetofuran (Ia-4) | tetramethylammonium thiocyanate | as per test |
| 134 | dinetofuran (Ia-4) | tetramethylammonium citrate | as per test |
| 135 | dinetofuran (Ia-4) | tetramethylammonium oxalate | as per test |
| 136 | dinetofuran (Ia-4) | tetramethylammonium formate | as per test |
| 137 | dinetofuran (Ia-4) | tetramethylammonium hydrogenphosphate | as per test |
| 138 | dinetofuran (Ia-4) | tetramethylammonium dihydrogenphosphate | as per test |
| 139 | dinetofuran (Ia-4) | tetraethylammonium sulphate | as per test |
| 140 | dinetofuran (Ia-4) | tetraethylammonium lactate | as per test |
| 141 | dinetofuran (Ia-4) | tetraethylammonium nitrate | as per test |
| 142 | dinetofuran (Ia-4) | tetraethylammonium thiosulphate | as per test |
| 143 | dinetofuran (Ia-4) | tetraethylammonium thiocyanate | as per test |
| 144 | dinetofuran (Ia-4) | tetraethylammonium citrate | as per test |
| 145 | dinetofuran (Ia-4) | tetraethylammonium oxalate | as per test |
| 146 | dinetofuran (Ia-4) | tetraethylammonium formate | as per test |
| 147 | dinetofuran (Ia-4) | tetraethylammonium hydrogenphosphate | as per test |
| 148 | dinetofuran (Ia-4) | tetraethylammonium dihydrogenphosphate | as per test |
| 149 | acetamiprid (Ia-5) | ammonium sulphate | as per test |
| 150 | acetamiprid (Ia-5) | ammonium lactate | as per test |
| 151 | acetamiprid (Ia-5) | ammonium nitrate | as per test |
| 152 | acetamiprid (Ia-5) | ammonium thiosulphate | as per test |
| 153 | acetamiprid (Ia-5) | ammonium thiocyanate | as per test |
| 154 | acetamiprid (Ia-5) | ammonium citrate | as per test |
| 155 | acetamiprid (Ia-5) | ammonium oxalate | as per test |
| 156 | acetamiprid (Ia-5) | ammonium formate | as per test |
| 157 | acetamiprid (Ia-5) | ammonium hydrogenphosphate | as per test |
| 158 | acetamiprid (Ia-5) | ammonium dihydrogenphosphate | as per test |
| 159 | acetamiprid (Ia-5) | ammonium carbonate | as per test |
| 160 | acetamiprid (Ia-5) | ammonium benzoate | as per test |
| 161 | acetamiprid (Ia-5) | ammonium sulphite | as per test |
| 162 | acetamiprid (Ia-5) | ammonium benzoate | as per test |
| 163 | acetamiprid (Ia-5) | ammonium hydrogenoxalate | as per test |
| 164 | acetamiprid (Ia-5) | ammonium hydrogencitrate | as per test |
| 165 | acetamiprid (Ia-5) | ammonium acetate | as per test |
| 166 | acetamiprid (Ia-5) | tetramethylammonium sulphate | as per test |
| 167 | acetamiprid (Ia-5) | tetramethylammonium lactate | as per test |
| 168 | acetamiprid (Ia-5) | tetramethylammonium nitrate | as per test |
| 169 | acetamiprid (Ia-5) | tetramethylammonium thiosulphate | as per test |
| 170 | acetamiprid (Ia-5) | tetramethylammonium thiocyanate | as per test |
| 171 | acetamiprid (Ia-5) | tetramethylammonium citrate | as per test |
| 172 | acetamiprid (Ia-5) | tetramethylammonium oxalate | as per test |
| 173 | acetamiprid (Ia-5) | tetramethylammonium formate | as per test |
| 174 | acetamiprid (Ia-5) | tetramethylammonium hydrogenphosphate | as per test |
| 175 | acetamiprid (Ia-5) | tetramethylammonium dihydrogenphosphate | as per test |
| 176 | acetamiprid (Ia-5) | tetraethylammonium sulphate | as per test |
| 177 | acetamiprid (Ia-5) | tetraethylammonium lactate | as per test |
| 178 | acetamiprid (Ia-5) | tetraethylammonium nitrate | as per test |
| 179 | acetamiprid (Ia-5) | tetraethylammonium thiosulphate | as per test |
| 180 | acetamiprid (Ia-5) | tetraethylammonium thiocyanate | as per test |
| 181 | acetamiprid (Ia-5) | tetraethylammonium citrate | as per test |
| 182 | acetamiprid (Ia-5) | tetraethylammonium oxalate | as per test |
| 183 | acetamiprid (Ia-5) | tetraethylammonium formate | as per test |
| 184 | acetamiprid (Ia-5) | tetraethylammonium hydrogenphosphate | as per test |
| 185 | acetamiprid (Ia-5) | tetraethylammonium dihydrogenphosphate | as per test |
| 186 | nitenpyram (Ia-6) | ammonium sulphate | as per test |
| 187 | nitenpyram (Ia-6) | ammonium lactate | as per test |
| 188 | nitenpyram (Ia-6) | ammonium nitrate | as per test |
| 189 | nitenpyram (Ia-6) | ammonium thiosulphate | as per test |
| 190 | nitenpyram (Ia-6) | ammonium thiocyanate | as per test |
| 191 | nitenpyram (Ia-6) | ammonium citrate | as per test |
| 192 | nitenpyram (Ia-6) | ammonium oxalate | as per test |
| 193 | nitenpyram (Ia-6) | ammonium formate | as per test |
| 194 | nitenpyram (Ia-6) | ammonium hydrogenphosphate | as per test |
| 195 | nitenpyram (Ia-6) | ammonium dihydrogenphosphate | as per test |
| 196 | nitenpyram (Ia-6) | ammonium carbonate | as per test |
| 197 | nitenpyram (Ia-6) | ammonium benzoate | as per test |
| 198 | nitenpyram (Ia-6) | ammonium sulphite | as per test |
| 199 | nitenpyram (Ia-6) | ammonium benzoate | as per test |
| 200 | nitenpyram (Ia-6) | ammonium hydrogenoxalate | as per test |
| 201 | nitenpyram (Ia-6) | ammonium hydrogencitrate | as per test |
| 202 | nitenpyram (Ia-6) | ammonium acetate | as per test |
| 203 | nitenpyram (Ia-6) | tetramethylammonium sulphate | as per test |
| 204 | nitenpyram (Ia-6) | tetramethylammonium lactate | as per test |
| 205 | nitenpyram (Ia-6) | tetramethylammonium nitrate | as per test |
| 206 | nitenpyram (Ia-6) | tetramethylammonium thiosulphate | as per test |
| 207 | nitenpyram (Ia-6) | tetramethylammonium thiocyanate | as per test |
| 208 | nitenpyram (Ia-6) | tetramethylammonium citrate | as per test |
| 209 | nitenpyram (Ia-6) | tetramethylammonium oxalate | as per test |
| 210 | nitenpyram (Ia-6) | tetramethylammonium formate | as per test |
| 211 | nitenpyram (Ia-6) | tetramethylammonium hydrogenphosphate | as per test |
| 212 | nitenpyram (Ia-6) | tetramethylammonium dihydrogenphosphate | as per test |
| 213 | nitenpyram (Ia-6) | tetraethylammonium sulphate | as per test |
| 214 | nitenpyram (Ia-6) | tetraethylammonium lactate | as per test |
| 215 | nitenpyram (Ia-6) | tetraethylammonium nitrate | as per test |
| 216 | nitenpyram (Ia-6) | tetraethylammonium thiosulphate | as per test |
| 217 | nitenpyram (Ia-6) | tetraethylammonium thiocyanate | as per test |
| 218 | nitenpyram (Ia-6) | tetraethylammonium citrate | as per test |
| 219 | nitenpyram (Ia-6) | tetraethylammonium oxalate | as per test |
| 220 | nitenpyram (Ia-6) | tetraethylammonium formate | as per test |
| 221 | nitenpyram (Ia-6) | tetraethylammonium hydrogenphosphate | as per test |
| 222 | nitenpyram (Ia-6) | tetraethylammonium dihydrogenphosphate | as per test |
| 223 | imidacloprid (Ia-7) | ammonium sulphate | as per test |
| 224 | imidacloprid (Ia-7) | ammonium lactate | as per test |
| 225 | imidacloprid (Ia-7) | ammonium nitrate | as per test |
| 226 | imidacloprid (Ia-7) | ammonium thiosulphate | as per test |
| 227 | imidacloprid (Ia-7) | ammonium thiocyanate | as per test |
| 228 | imidacloprid (Ia-7) | ammonium citrate | as per test |
| 229 | imidacloprid (Ia-7) | ammonium oxalate | as per test |
| 230 | imidacloprid (Ia-7) | ammonium formate | as per test |
| 231 | imidacloprid (Ia-7) | ammonium hydrogenphosphate | as per test |
| 232 | imidacloprid (Ia-7) | ammonium dihydrogenphosphate | as per test |
| 233 | imidacloprid (Ia-7) | ammonium carbonate | as per test |
| 234 | imidacloprid (Ia-7) | ammonium benzoate | as per test |
| 235 | imidacloprid (Ia-7) | ammonium sulphite | as per test |
| 236 | imidacloprid (Ia-7) | ammonium benzoate | as per test |
| 237 | imidacloprid (Ia-7) | ammonium hydrogenoxalate | as per test |
| 238 | imidacloprid (Ia-7) | ammonium hydrogencitrate | as per test |
| 239 | imidacloprid (Ia-7) | ammonium acetate | as per test |
| 240 | imidacloprid (Ia-7) | tetramethylammonium sulphate | as per test |
| 241 | imidacloprid (Ia-7) | tetramethylammonium lactate | as per test |
| 242 | imidacloprid (Ia-7) | tetramethylammonium nitrate | as per test |
| 243 | imidacloprid (Ia-7) | tetramethylammonium thiosulphate | as per test |
| 244 | imidacloprid (Ia-7) | tetramethylammonium thiocyanate | as per test |
| 245 | imidacloprid (Ia-7) | tetramethylammonium citrate | as per test |
| 246 | imidacloprid (Ia-7) | tetramethylammonium oxalate | as per test |
| 247 | imidacloprid (Ia-7) | tetramethylammonium formate | as per test |
| 248 | imidacloprid (Ia-7) | tetramethylammonium hydrogenphosphate | as per test |
| 249 | imidacloprid (Ia-7) | tetramethylammonium dihydrogenphosphate | as per test |
| 250 | imidacloprid (Ia-7) | tetraethylammonium sulphate | as per test |
| 251 | imidacloprid (Ia-7) | tetraethylammonium lactate | as per test |
| 252 | imidacloprid (Ia-7) | tetraethylammonium nitrate | as per test |
| 253 | imidacloprid (Ia-7) | tetraethylammonium thiosulphate | as per test |
| 254 | imidacloprid (Ia-7) | tetraethylammonium thiocyanate | as per test |
| 255 | imidacloprid (Ia-7) | tetraethylammonium citrate | as per test |
| 256 | imidacloprid (Ia-7) | tetraethylammonium oxalate | as per test |
| 257 | imidacloprid (Ia-7) | tetraethylammonium formate | as per test |
| 258 | imidacloprid (Ia-7) | tetraethylammonium hydrogenphosphate | as per test |
| 259 | imidacloprid (Ia-7) | tetraethylammonium dihydrogenphosphate | as per test |
| 260 | imidaclothiz (Ia-8) | ammonium sulphate | as per test |
| 261 | imidaclothiz (Ia-8) | ammonium lactate | as per test |
| 262 | imidaclothiz (Ia-8) | ammonium nitrate | as per test |
| 263 | imidaclothiz (Ia-8) | ammonium thiosulphate | as per test |
| 264 | imidaclothiz (Ia-8) | ammonium thiocyanate | as per test |
| 265 | imidaclothiz (Ia-8) | ammonium citrate | as per test |
| 266 | imidaclothiz (Ia-8) | ammonium oxalate | as per test |
| 267 | imidaclothiz (Ia-8) | ammonium formate | as per test |
| 268 | imidaclothiz (Ia-8) | ammonium hydrogenphosphate | as per test |
| 269 | imidaclothiz (Ia-8) | ammonium dihydrogenphosphate | as per test |
| 270 | imidaclothiz (Ia-8) | ammonium carbonate | as per test |
| 271 | imidaclothiz (Ia-8) | ammonium benzoate | as per test |
| 272 | imidaclothiz (Ia-8) | ammonium sulphite | as per test |
| 273 | imidaclothiz (Ia-8) | ammonium benzoate | as per test |
| 274 | imidaclothiz (Ia-8) | ammonium hydrogenoxalate | as per test |
| 275 | imidaclothiz (Ia-8) | ammonium hydrogencitrate | as per test |
| 276 | imidaclothiz (Ia-8) | ammonium acetate | as per test |
| 277 | imidaclothiz (Ia-8) | tetramethylammonium sulphate | as per test |
| 278 | imidaclothiz (Ia-8) | tetramethylammonium lactate | as per test |
| 279 | imidaclothiz (Ia-8) | tetramethylammonium nitrate | as per test |
| 280 | imidaclothiz (Ia-8) | tetramethylammonium thiosulphate | as per test |
| 281 | imidaclothiz (Ia-8) | tetramethylammonium thiocyanate | as per test |
| 282 | imidaclothiz (Ia-8) | tetramethylammonium citrate | as per test |
| 283 | imidaclothiz (Ia-8) | tetramethylammonium oxalate | as per test |
| 284 | imidaclothiz (Ia-8) | tetramethylammonium formate | as per test |
| 285 | imidaclothiz (Ia-8) | tetramethylammonium hydrogenphosphate | as per test |
| 286 | imidaclothiz (Ia-8) | tetramethylammonium dihydrogenphosphate | as per test |
| 287 | imidaclothiz (Ia-8) | tetraethylammonium sulphate | as per test |
| 288 | imidaclothiz (Ia-8) | tetraethylammonium lactate | as per test |
| 289 | imidaclothiz (Ia-8) | tetraethylammonium nitrate | as per test |
| 290 | imidaclothiz (Ia-8) | tetraethylammonium thiosulphate | as per test |
| 291 | imidaclothiz (Ia-8) | tetraethylammonium thiocyanate | as per test |
| 292 | imidaclothiz (Ia-8) | tetraethylammonium citrate | as per test |
| 293 | imidaclothiz (Ia-8) | tetraethylammonium oxalate | as per test |
| 294 | imidaclothiz (Ia-8) | tetraethylammonium formate | as per test |
| 295 | imidaclothiz (Ia-8) | tetraethylammonium hydrogenphosphate | as per test |
| 296 | imidaclothiz (Ia-8) | tetraethylammonium dihydrogenphosphate | as per test |
| 297 | AKD-1022 (Ia-9) | ammonium sulphate | as per test |
| 298 | AKD-1022 (Ia-9) | ammonium lactate | as per test |
| 299 | AKD-1022 (Ia-9) | ammonium nitrate | as per test |
| 300 | AKD-1022 (Ia-9) | ammonium thiosulphate | as per test |
| 301 | AKD-1022 (Ia-9) | ammonium thiocyanate | as per test |
| 302 | AKD-1022 (Ia-9) | ammonium citrate | as per test |
| 303 | AKD-1022 (Ia-9) | ammonium oxalate | as per test |
| 304 | AKD-1022 (Ia-9) | ammonium formate | as per test |
| 305 | AKD-1022 (Ia-9) | ammonium hydrogenphosphate | as per test |
| 306 | AKD-1022 (Ia-9) | ammonium dihydrogenphosphate | as per test |
| 307 | AKD-1022 (Ia-9) | ammonium carbonate | as per test |
| 308 | AKD-1022 (Ia-9) | ammonium benzoate | as per test |
| 309 | AKD-1022 (Ia-9) | ammonium sulphite | as per test |
| 310 | AKD-1022 (Ia-9) | ammonium benzoate | as per test |
| 311 | AKD-1022 (Ia-9) | ammonium hydrogenoxalate | as per test |
| 312 | AKD-1022 (Ia-9) | ammonium hydrogencitrate | as per test |
| 313 | AKD-1022 (Ia-9) | ammonium acetate | as per test |
| 314 | AKD-1022 (Ia-9) | tetramethylammonium sulphate | as per test |
| 315 | AKD-1022 (Ia-9) | tetramethylammonium lactate | as per test |
| 316 | AKD-1022 (Ia-9) | tetramethylammonium nitrate | as per test |
| 317 | AKD-1022 (Ia-9) | tetramethylammonium thiosulphate | as per test |
| 318 | AKD-1022 (Ia-9) | tetramethylammonium thiocyanate | as per test |
| 319 | AKD-1022 (Ia-9) | tetramethylammonium citrate | as per test |
| 320 | AKD-1022 (Ia-9) | tetramethylammonium oxalate | as per test |
| 321 | AKD-1022 (Ia-9) | tetramethylammonium formate | as per test |
| 322 | AKD-1022 (Ia-9) | tetramethylammonium hydrogenphosphate | as per test |
| 323 | AKD-1022 (Ia-9) | tetramethylammonium dihydrogenphosphate | as per test |
| 324 | AKD-1022 (Ia-9) | tetraethylammonium sulphate | as per test |
| 325 | AKD-1022 (Ia-9) | tetraethylammonium lactate | as per test |
| 326 | AKD-1022 (Ia-9) | tetraethylammonium nitrate | as per test |
| 327 | AKD-1022 (Ia-9) | tetraethylammonium thiosulphate | as per test |
| 328 | AKD-1022 (Ia-9) | tetraethylammonium thiocyanate | as per test |
| 329 | AKD-1022 (Ia-9) | tetraethylammonium citrate | as per test |
| 330 | AKD-1022 (Ia-9) | tetraethylammonium oxalate | as per test |
| 331 | AKD-1022 (Ia-9) | tetraethylammonium formate | as per test |
| 332 | AKD-1022 (Ia-9) | tetraethylammonium hydrogenphosphate | as per test |
| 333 | AKD-1022 (Ia-9) | tetraethylammonium dihydrogenphosphate | as per test |
| 334 | (Ib-1) | ammonium sulphate | as per test |
| 335 | (Ib-1) | ammonium lactate | as per test |
| 336 | (Ib-1) | ammonium nitrate | as per test |
| 337 | (Ib-1) | ammonium thiosulphate | as per test |
| 338 | (Ib-1) | ammonium thiocyanate | as per test |
| 339 | (Ib-1) | ammonium citrate | as per test |
| 340 | (Ib-1) | ammonium oxalate | as per test |
| 341 | (Ib-1) | ammonium formate | as per test |
| 342 | (Ib-1) | ammonium hydrogenphosphate | as per test |
| 343 | (Ib-1) | ammonium dihydrogenphosphate | as per test |
| 344 | (Ib-1) | ammonium carbonate | as per test |
| 345 | (Ib-1) | ammonium benzoate | as per test |
| 346 | (Ib-1) | ammonium sulphite | as per test |
| 347 | (Ib-1) | ammonium benzoate | as per test |
| 348 | (Ib-1) | ammonium hydrogenoxalate | as per test |
| 349 | (Ib-1) | ammonium hydrogencitrate | as per test |
| 350 | (Ib-1) | ammonium acetate | as per test |
| 351 | (Ib-1) | tetramethylammonium sulphate | as per test |
| 352 | (Ib-1) | tetramethylammonium lactate | as per test |
| 353 | (Ib-1) | tetramethylammonium nitrate | as per test |
| 354 | (Ib-1) | tetramethylammonium thiosulphate | as per test |
| 355 | (Ib-1) | tetramethylammonium thiocyanate | as per test |
| 356 | (Ib-1) | tetramethylammonium citrate | as per test |
| 357 | (Ib-1) | tetramethylammonium oxalate | as per test |
| 358 | (Ib-1) | tetramethylammonium formate | as per test |
| 359 | (Ib-1) | tetramethylammonium hydrogenphosphate | as per test |
| 360 | (Ib-1) | tetramethylammonium dihydrogenphosphate | as per test |
| 361 | (Ib-1) | tetraethylammonium sulphate | as per test |
| 362 | (Ib-1) | tetraethylammonium lactate | as per test |
| 363 | (Ib-1) | tetraethylammonium nitrate | as per test |
| 364 | (Ib-1) | tetraethylammonium thiosulphate | as per test |
| 365 | (Ib-1) | tetraethylammonium thiocyanate | as per test |
| 366 | (Ib-1) | tetraethylammonium citrate | as per test |
| 367 | (Ib-1) | tetraethylammonium oxalate | as per test |
| 368 | (Ib-1) | tetraethylammonium formate | as per test |
| 369 | (Ib-1) | tetraethylammonium hydrogenphosphate | as per test |
| 370 | (Ib-1) | tetraethylammonium dihydrogenphosphate | as per test |
| 371 | (Ib-2) | ammonium sulphate | as per test |
| 372 | (Ib-2) | ammonium lactate | as per test |
| 373 | (Ib-2) | ammonium nitrate | as per test |
| 374 | (Ib-2) | ammonium thiosulphate | as per test |
| 375 | (Ib-2) | ammonium thiocyanate | as per test |
| 376 | (Ib-2) | ammonium citrate | as per test |
| 377 | (Ib-2) | ammonium oxalate | as per test |
| 378 | (Ib-2) | ammonium formate | as per test |
| 379 | (Ib-2) | ammonium hydrogenphosphate | as per test |
| 380 | (Ib-2) | ammonium dihydrogenphosphate | as per test |
| 381 | (Ib-2) | ammonium carbonate | as per test |
| 382 | (Ib-2) | ammonium benzoate | as per test |
| 383 | (Ib-2) | ammonium sulphite | as per test |
| 384 | (Ib-2) | ammonium benzoate | as per test |
| 385 | (Ib-2) | ammonium hydrogenoxalate | as per test |
| 386 | (Ib-2) | ammonium hydrogencitrate | as per test |
| 387 | (Ib-2) | ammonium acetate | as per test |
| 388 | (Ib-2) | tetramethylammonium sulphate | as per test |
| 389 | (Ib-2) | tetramethylammonium lactate | as per test |
| 390 | (Ib-2) | tetramethylammonium nitrate | as per test |
| 391 | (Ib-2) | tetramethylammonium thiosulphate | as per test |
| 392 | (Ib-2) | tetramethylammonium thiocyanate | as per test |
| 393 | (Ib-2) | tetramethylammonium citrate | as per test |
| 394 | (Ib-2) | tetramethylammonium oxalate | as per test |
| 395 | (Ib-2) | tetramethylammonium formate | as per test |
| 396 | (Ib-2) | tetramethylammonium hydrogenphosphate | as per test |
| 397 | (Ib-2) | tetramethylammonium dihydrogenphosphate | as per test |
| 398 | (Ib-2) | tetraethylammonium sulphate | as per test |
| 399 | (Ib-2) | tetraethylammonium lactate | as per test |
| 400 | (Ib-2) | tetraethylammonium nitrate | as per test |
| 401 | (Ib-2) | tetraethylammonium thiosulphate | as per test |
| 402 | (Ib-2) | tetraethylammonium thiocyanate | as per test |
| 403 | (Ib-2) | tetraethylammonium citrate | as per test |
| 404 | (Ib-2) | tetraethylammonium oxalate | as per test |
| 405 | (Ib-2) | tetraethylammonium formate | as per test |
| 406 | (Ib-2) | tetraethylammonium hydrogenphosphate | as per test |
| 407 | (Ib-2) | tetraethylammonium dihydrogenphosphate | as per test |
| 408 | (Ib-3) | ammonium sulphate | as per test |
| 409 | (Ib-3) | ammonium lactate | as per test |
| 410 | (Ib-3) | ammonium nitrate | as per test |
| 411 | (Ib-3) | ammonium thiosulphate | as per test |
| 412 | (Ib-3) | ammonium thiocyanate | as per test |
| 413 | (Ib-3) | ammonium citrate | as per test |
| 414 | (Ib-3) | ammonium oxalate | as per test |
| 415 | (Ib-3) | ammonium formate | as per test |
| 416 | (Ib-3) | ammonium hydrogenphosphate | as per test |
| 417 | (Ib-3) | ammonium dihydrogenphosphate | as per test |
| 418 | (Ib-3) | ammonium carbonate | as per test |
| 419 | (Ib-3) | ammonium benzoate | as per test |
| 420 | (Ib-3) | ammonium sulphite | as per test |
| 421 | (Ib-3) | ammonium benzoate | as per test |
| 422 | (Ib-3) | ammonium hydrogenoxalate | as per test |
| 423 | (Ib-3) | ammonium hydrogencitrate | as per test |
| 424 | (Ib-3) | ammonium acetate | as per test |
| 425 | (Ib-3) | tetramethylammonium sulphate | as per test |
| 426 | (Ib-3) | tetramethylammonium lactate | as per test |
| 427 | (Ib-3) | tetramethylammonium nitrate | as per test |
| 428 | (Ib-3) | tetramethylammonium thiosulphate | as per test |
| 429 | (Ib-3) | tetramethylammonium thiocyanate | as per test |
| 430 | (Ib-3) | tetramethylammonium citrate | as per test |
| 431 | (Ib-3) | tetramethylammonium oxalate | as per test |
| 432 | (Ib-3) | tetramethylammonium formate | as per test |
| 433 | (Ib-3) | tetramethylammonium hydrogenphosphate | as per test |
| 434 | (Ib-3) | tetramethylammonium dihydrogenphosphate | as per test |
| 435 | (Ib-3) | tetraethylammonium sulphate | as per test |
| 436 | (Ib-3) | tetraethylammonium lactate | as per test |
| 437 | (Ib-3) | tetraethylammonium nitrate | as per test |
| 438 | (Ib-3) | tetraethylammonium thiosulphate | as per test |
| 439 | (Ib-3) | tetraethylammonium thiocyanate | as per test |
| 440 | (Ib-3) | tetraethylammonium citrate | as per test |
| 441 | (Ib-3) | tetraethylammonium oxalate | as per test |
| 442 | (Ib-3) | tetraethylammonium formate | as per test |
| 443 | (Ib-3) | tetraethylammonium hydrogenphosphate | as per test |
| 444 | (Ib-3) | tetraethylammonium dihydrogenphosphate | as per test |
| 445 | (Ic-1) | ammonium sulphate | as per test |
| 446 | (Ic-1) | ammonium lactate | as per test |
| 447 | (Ic-1) | ammonium nitrate | as per test |
| 448 | (Ic-1) | ammonium thiosulphate | as per test |
| 449 | (Ic-1) | ammonium thiocyanate | as per test |
| 450 | (Ic-1) | ammonium citrate | as per test |
| 451 | (Ic-1) | ammonium oxalate | as per test |
| 452 | (Ic-1) | ammonium formate | as per test |
| 453 | (Ic-1) | ammonium hydrogenphosphate | as per test |
| 454 | (Ic-1) | ammonium dihydrogenphosphate | as per test |
| 455 | (Ic-1) | ammonium carbonate | as per test |
| 456 | (Ic-1) | ammonium benzoate | as per test |
| 457 | (Ic-1) | ammonium sulphite | as per test |
| 458 | (Ic-1) | ammonium benzoate | as per test |
| 459 | (Ic-1) | ammonium hydrogenoxalate | as per test |
| 460 | (Ic-1) | ammonium hydrogencitrate | as per test |
| 461 | (Ic-1) | ammonium acetate | as per test |
| 462 | (Ic-1) | tetramethylammonium sulphate | as per test |
| 463 | (Ic-1) | tetramethylammonium lactate | as per test |
| 464 | (Ic-1) | tetramethylammonium nitrate | as per test |
| 465 | (Ic-1) | tetramethylammonium thiosulphate | as per test |
| 466 | (Ic-1) | tetramethylammonium thiocyanate | as per test |
| 467 | (Ic-1) | tetramethylammonium citrate | as per test |
| 468 | (Ic-1) | tetramethylammonium oxalate | as per test |
| 469 | (Ic-1) | tetramethylammonium formate | as per test |
| 470 | (Ic-1) | tetramethylammonium hydrogenphosphate | as per test |
| 471 | (Ic-1) | tetramethylammonium dihydrogenphosphate | as per test |
| 472 | (Ic-1) | tetraethylammonium sulphate | as per test |
| 473 | (Ic-1) | tetraethylammonium lactate | as per test |
| 474 | (Ic-1) | tetraethylammonium nitrate | as per test |
| 475 | (Ic-1) | tetraethylammonium thiosulphate | as per test |
| 476 | (Ic-1) | tetraethylammonium thiocyanate | as per test |
| 477 | (Ic-1) | tetraethylammonium citrate | as per test |
| 478 | (Ic-1) | tetraethylammonium oxalate | as per test |
| 479 | (Ic-1) | tetraethylammonium formate | as per test |
| 480 | (Ic-1) | tetraethylammonium hydrogenphosphate | as per test |
| 481 | (Ic-1) | tetraethylammonium dihydrogenphosphate | as per test |
| 482 | (Id-1) | ammonium sulphate | as per test |
| 483 | (Id-1) | ammonium lactate | as per test |
| 484 | (Id-1) | ammonium nitrate | as per test |
| 485 | (Id-1) | ammonium thiosulphate | as per test |
| 486 | (Id-1) | ammonium thiocyanate | as per test |
| 487 | (Id-1) | ammonium citrate | as per test |
| 488 | (Id-1) | ammonium oxalate | as per test |
| 489 | (Id-1) | ammonium formate | as per test |
| 490 | (Id-1) | ammonium hydrogenphosphate | as per test |
| 491 | (Id-1) | ammonium dihydrogenphosphate | as per test |
| 492 | (Id-1) | ammonium carbonate | as per test |
| 493 | (Id-1) | ammonium benzoate | as per test |
| 494 | (Id-1) | ammonium sulphite | as per test |
| 495 | (Id-1) | ammonium benzoate | as per test |
| 496 | (Id-1) | ammonium hydrogenoxalate | as per test |
| 497 | (Id-1) | ammonium hydrogencitrate | as per test |
| 498 | (Id-1) | ammonium acetate | as per test |
| 499 | (Id-1) | tetramethylammonium sulphate | as per test |
| 500 | (Id-1) | tetramethylammonium lactate | as per test |
| 501 | (Id-1) | tetramethylammonium nitrate | as per test |
| 502 | (Id-1) | tetramethylammonium thiosulphate | as per test |
| 503 | (Id-1) | tetramethylammonium thiocyanate | as per test |
| 504 | (Id-1) | tetramethylammonium citrate | as per test |
| 505 | (Id-1) | tetramethylammonium oxalate | as per test |
| 506 | (Id-1) | tetramethylammonium formate | as per test |
| 507 | (Id-1) | tetramethylammonium hydrogenphosphate | as per test |
| 508 | (Id-1) | tetramethylammonium dihydrogenphosphate | as per test |
| 509 | (Id-1) | tetraethylammonium sulphate | as per test |
| 510 | (Id-1) | tetraethylammonium lactate | as per test |
| 511 | (Id-1) | tetraethylammonium nitrate | as per test |
| 512 | (Id-1) | tetraethylammonium thiosulphate | as per test |
| 513 | (Id-1) | tetraethylammonium thiocyanate | as per test |
| 514 | (Id-1) | tetraethylammonium citrate | as per test |
| 515 | (Id-1) | tetraethylammonium oxalate | as per test |
| 516 | (Id-1) | tetraethylammonium formate | as per test |
| 517 | (Id-1) | tetraethylammonium hydrogenphosphate | as per test |
| 518 | (Id-1) | tetraethylammonium dihydrogenphosphate | as per test |
| 519 | (Id-2) | ammonium sulphate | as per test |
| 520 | (Id-2) | ammonium lactate | as per test |
| 521 | (Id-2) | ammonium nitrate | as per test |
| 522 | (Id-2) | ammonium thiosulphate | as per test |
| 523 | (Id-2) | ammonium thiocyanate | as per test |
| 524 | (Id-2) | ammonium citrate | as per test |
| 525 | (Id-2) | ammonium oxalate | as per test |
| 526 | (Id-2) | ammonium formate | as per test |
| 527 | (Id-2) | ammonium hydrogenphosphate | as per test |
| 528 | (Id-2) | ammonium dihydrogenphosphate | as per test |
| 529 | (Id-2) | ammonium carbonate | as per test |
| 530 | (Id-2) | ammonium benzoate | as per test |
| 531 | (Id-2) | ammonium sulphite | as per test |
| 532 | (Id-2) | ammonium benzoate | as per test |
| 533 | (Id-2) | ammonium hydrogenoxalate | as per test |
| 534 | (Id-2) | ammonium hydrogencitrate | as per test |
| 535 | (Id-2) | ammonium acetate | as per test |
| 536 | (Id-2) | tetramethylammonium sulphate | as per test |
| 537 | (Id-2) | tetramethylammonium lactate | as per test |
| 538 | (Id-2) | tetramethylammonium nitrate | as per test |
| 539 | (Id-2) | tetramethylammonium thiosulphate | as per test |
| 540 | (Id-2) | tetramethylammonium thiocyanate | as per test |
| 541 | (Id-2) | tetramethylammonium citrate | as per test |
| 542 | (Id-2) | tetramethylammonium oxalate | as per test |
| 543 | (Id-2) | tetramethylammonium formate | as per test |
| 544 | (Id-2) | tetramethylammonium hydrogenphosphate | as per test |
| 545 | (Id-2) | tetramethylammonium dihydrogenphosphate | as per test |
| 546 | (Id-2) | tetraethylammonium sulphate | as per test |
| 547 | (Id-2) | tetraethylammonium lactate | as per test |
| 548 | (Id-2) | tetraethylammonium nitrate | as per test |
| 549 | (Id-2) | tetraethylammonium thiosulphate | as per test |
| 550 | (Id-2) | tetraethylammonium thiocyanate | as per test |
| 551 | (Id-2) | tetraethylammonium citrate | as per test |
| 552 | (Id-2) | tetraethylammonium oxalate | as per test |
| 553 | (Id-2) | tetraethylammonium formate | as per test |
| 554 | (Id-2) | tetraethylammonium hydrogenphosphate | as per test |
| 555 | (Id-2) | tetraethylammonium dihydrogenphosphate | as per test |
| 556 | (Ie-1) | ammonium sulphate | as per test |
| 557 | (Ie-1) | ammonium lactate | as per test |
| 558 | (Ie-1) | ammonium nitrate | as per test |
| 559 | (Ie-1) | ammonium thiosulphate | as per test |
| 560 | (Ie-1) | ammonium thiocyanate | as per test |
| 561 | (Ie-1) | ammonium citrate | as per test |
| 562 | (Ie-1) | ammonium oxalate | as per test |
| 563 | (Ie-1) | ammonium formate | as per test |
| 564 | (Ie-1) | ammonium hydrogenphosphate | as per test |
| 565 | (Ie-1) | ammonium dihydrogenphosphate | as per test |
| 566 | (Ie-1) | ammonium carbonate | as per test |
| 567 | (Ie-1) | ammonium benzoate | as per test |
| 568 | (Ie-1) | ammonium sulphite | as per test |
| 569 | (Ie-1) | ammonium benzoate | as per test |
| 570 | (Ie-1) | ammonium hydrogenoxalate | as per test |
| 571 | (Ie-1) | ammonium hydrogencitrate | as per test |
| 572 | (Ie-1) | ammonium acetate | as per test |
| 573 | (Ie-1) | tetramethylammonium sulphate | as per test |
| 574 | (Ie-1) | tetramethylammonium lactate | as per test |
| 575 | (Ie-1) | tetramethylammonium nitrate | as per test |
| 576 | (Ie-1) | tetramethylammonium thiosulphate | as per test |
| 577 | (Ie-1) | tetramethylammonium thiocyanate | as per test |
| 578 | (Ie-1) | tetramethylammonium citrate | as per test |
| 579 | (Ie-1) | tetramethylammonium oxalate | as per test |
| 580 | (Ie-1) | tetramethylammonium formate | as per test |
| 581 | (Ie-1) | tetramethylammonium hydrogenphosphate | as per test |
| 582 | (Ie-1) | tetramethylammonium dihydrogenphosphate | as per test |
| 583 | (Ie-1) | tetraethylammonium sulphate | as per test |
| 584 | (Ie-1) | tetraethylammonium lactate | as per test |
| 585 | (Ie-1) | tetraethylammonium nitrate | as per test |
| 586 | (Ie-1) | tetraethylammonium thiosulphate | as per test |
| 587 | (Ie-1) | tetraethylammonium thiocyanate | as per test |
| 588 | (Ie-1) | tetraethylammonium citrate | as per test |
| 589 | (Ie-1) | tetraethylammonium oxalate | as per test |
| 590 | (Ie-1) | tetraethylammonium formate | as per test |
| 591 | (Ie-1) | tetraethylammonium hydrogenphosphate | as per test |
| 592 | (Ie-1) | tetraethylammonium dihydrogenphosphate | as per test |
| 593 | (Ie-2) | ammonium sulphate | as per test |
| 594 | (Ie-2) | ammonium lactate | as per test |
| 595 | (Ie-2) | ammonium nitrate | as per test |
| 596 | (Ie-2) | ammonium thiosulphate | as per test |
| 597 | (Ie-2) | ammonium thiocyanate | as per test |
| 598 | (Ie-2) | ammonium citrate | as per test |
| 599 | (Ie-2) | ammonium oxalate | as per test |
| 600 | (Ie-2) | ammonium formate | as per test |
| 601 | (Ie-2) | ammonium hydrogenphosphate | as per test |
| 602 | (Ie-2) | ammonium dihydrogenphosphate | as per test |
| 603 | (Ie-2) | ammonium carbonate | as per test |
| 604 | (Ie-2) | ammonium benzoate | as per test |
| 605 | (Ie-2) | ammonium sulphite | as per test |
| 606 | (Ie-2) | ammonium benzoate | as per test |
| 607 | (Ie-2) | ammonium hydrogenoxalate | as per test |
| 608 | (Ie-2) | ammonium hydrogencitrate | as per test |
| 609 | (Ie-2) | ammonium acetate | as per test |
| 610 | (Ie-2) | tetramethylammonium sulphate | as per test |
| 611 | (Ie-2) | tetramethylammonium lactate | as per test |
| 612 | (Ie-2) | tetramethylammonium nitrate | as per test |
| 613 | (Ie-2) | tetramethylammonium thiosulphate | as per test |
| 614 | (Ie-2) | tetramethylammonium thiocyanate | as per test |
| 615 | (Ie-2) | tetramethylammonium citrate | as per test |
| 616 | (Ie-2) | tetramethylammonium oxalate | as per test |
| 617 | (Ie-2) | tetramethylammonium formate | as per test |
| 618 | (Ie-2) | tetramethylammonium hydrogenphosphate | as per test |
| 619 | (Ie-2) | tetramethylammonium dihydrogenphosphate | as per test |
| 620 | (Ie-2) | tetraethylammonium sulphate | as per test |
| 621 | (Ie-2) | tetraethylammonium lactate | as per test |
| 622 | (Ie-2) | tetraethylammonium nitrate | as per test |
| 623 | (Ie-2) | tetraethylammonium thiosulphate | as per test |
| 624 | (Ie-2) | tetraethylammonium thiocyanate | as per test |
| 625 | (Ie-2) | tetraethylammonium citrate | as per test |
| 626 | (Ie-2) | tetraethylammonium oxalate | as per test |
| 627 | (Ie-2) | tetraethylammonium formate | as per test |
| 628 | (Ie-2) | tetraethylammonium hydrogenphosphate | as per test |
| 629 | (Ie-2) | tetraethylammonium dihydrogenphosphate | as per test |
| 630 | (If-1) | ammonium sulphate | as per test |
| 631 | (If-1) | ammonium lactate | as per test |
| 632 | (If-1) | ammonium nitrate | as per test |
| 633 | (If-1) | ammonium thiosulphate | as per test |
| 634 | (If-1) | ammonium thiocyanate | as per test |
| 635 | (If-1) | ammonium citrate | as per test |
| 636 | (If-1) | ammonium oxalate | as per test |
| 637 | (If-1) | ammonium formate | as per test |
| 638 | (If-1) | ammonium hydrogenphosphate | as per test |
| 639 | (If-1) | ammonium dihydrogenphosphate | as per test |
| 640 | (If-1) | ammonium carbonate | as per test |
| 641 | (If-1) | ammonium benzoate | as per test |
| 642 | (If-1) | ammonium sulphite | as per test |
| 643 | (If-1) | ammonium benzoate | as per test |
| 644 | (If-1) | ammonium hydrogenoxalate | as per test |
| 645 | (If-1) | ammonium hydrogencitrate | as per test |
| 646 | (If-1) | ammonium acetate | as per test |
| 647 | (If-1) | tetramethylammonium sulphate | as per test |
| 648 | (If-1) | tetramethylammonium lactate | as per test |
| 649 | (If-1) | tetramethylammonium nitrate | as per test |
| 650 | (If-1) | tetramethylammonium thiosulphate | as per test |
| 651 | (If-1) | tetramethylammonium thiocyanate | as per test |
| 652 | (If-1) | tetramethylammonium citrate | as per test |
| 653 | (If-1) | tetramethylammonium oxalate | as per test |
| 654 | (If-1) | tetramethylammonium formate | as per test |
| 655 | (If-1) | tetramethylammonium hydrogenphosphate | as per test |
| 656 | (If-1) | tetramethylammonium dihydrogenphosphate | as per test |
| 657 | (If-1) | tetraethylammonium sulphate | as per test |
| 658 | (If-1) | tetraethylammonium lactate | as per test |
| 659 | (If-1) | tetraethylammonium nitrate | as per test |
| 660 | (If-1) | tetraethylammonium thiosulphate | as per test |
| 661 | (If-1) | tetraethylammonium thiocyanate | as per test |
| 662 | (If-1) | tetraethylammonium citrate | as per test |
| 663 | (If-1) | tetraethylammonium oxalate | as per test |
| 664 | (If-1) | tetraethylammonium formate | as per test |
| 665 | (If-1) | tetraethylammonium hydrogenphosphate | as per test |
| 666 | (If-1) | tetraethylammonium dihydrogenphosphate | as per test |
| 667 | (If-2) | ammonium sulphate | as per test |
| 668 | (If-2) | ammonium lactate | as per test |
| 669 | (If-2) | ammonium nitrate | as per test |
| 670 | (If-2) | ammonium thiosulphate | as per test |
| 671 | (If-2) | ammonium thiocyanate | as per test |
| 672 | (If-2) | ammonium citrate | as per test |
| 673 | (If-2) | ammonium oxalate | as per test |
| 674 | (If-2) | ammonium formate | as per test |
| 675 | (If-2) | ammonium hydrogenphosphate | as per test |
| 676 | (If-2) | ammonium dihydrogenphosphate | as per test |
| 677 | (If-2) | ammonium carbonate | as per test |
| 678 | (If-2) | ammonium benzoate | as per test |
| 679 | (If-2) | ammonium sulphite | as per test |
| 680 | (If-2) | ammonium benzoate | as per test |
| 681 | (If-2) | ammonium hydrogenoxalate | as per test |
| 682 | (If-2) | ammonium hydrogencitrate | as per test |
| 683 | (If-2) | ammonium acetate | as per test |
| 684 | (If-2) | tetramethylammonium sulphate | as per test |
| 685 | (If-2) | tetramethylammonium lactate | as per test |
| 686 | (If-2) | tetramethylammonium nitrate | as per test |
| 687 | (If-2) | tetramethylammonium thiosulphate | as per test |
| 688 | (If-2) | tetramethylammonium thiocyanate | as per test |
| 689 | (If-2) | tetramethylammonium citrate | as per test |
| 690 | (If-2) | tetramethylammonium oxalate | as per test |
| 691 | (If-2) | tetramethylammonium formate | as per test |
| 692 | (If-2) | tetramethylammonium hydrogenphosphate | as per test |
| 693 | (If-2) | tetramethylammonium dihydrogenphosphate | as per test |
| 694 | (If-2) | tetraethylammonium sulphate | as per test |
| 695 | (If-2) | tetraethylammonium lactate | as per test |
| 696 | (If-2) | tetraethylammonium nitrate | as per test |
| 697 | (If-2) | tetraethylammonium thiosulphate | as per test |
| 698 | (If-2) | tetraethylammonium thiocyanate | as per test |
| 699 | (If-2) | tetraethylammonium citrate | as per test |
| 700 | (If-2) | tetraethylammonium oxalate | as per test |
| 701 | (If-2) | tetraethylammonium formate | as per test |
| 702 | (If-2) | tetraethylammonium hydrogenphosphate | as per test |
| 703 | (If-2) | tetraethylammonium dihydrogenphosphate | as per test |
| 704 | (Ig-1) | ammonium sulphate | as per test |
| 705 | (Ig-1) | ammonium lactate | as per test |
| 706 | (Ig-1) | ammonium nitrate | as per test |
| 707 | (Ig-1) | ammonium thiosulphate | as per test |
| 708 | (Ig-1) | ammonium thiocyanate | as per test |
| 709 | (Ig-1) | ammonium citrate | as per test |
| 710 | (Ig-1) | ammonium oxalate | as per test |
| 711 | (Ig-1) | ammonium formate | as per test |
| 712 | (Ig-1) | ammonium hydrogenphosphate | as per test |
| 713 | (Ig-1) | ammonium dihydrogenphosphate | as per test |
| 714 | (Ig-1) | ammonium carbonate | as per test |
| 715 | (Ig-1) | ammonium benzoate | as per test |
| 716 | (Ig-1) | ammonium sulphite | as per test |
| 717 | (Ig-1) | ammonium benzoate | as per test |
| 718 | (Ig-1) | ammonium hydrogenoxalate | as per test |
| 719 | (Ig-1) | ammonium hydrogencitrate | as per test |
| 720 | (Ig-1) | ammonium acetate | as per test |
| 721 | (Ig-1) | tetramethylammonium sulphate | as per test |
| 722 | (Ig-1) | tetramethylammonium lactate | as per test |
| 723 | (Ig-1) | tetramethylammonium nitrate | as per test |
| 724 | (Ig-1) | tetramethylammonium thiosulphate | as per test |
| 725 | (Ig-1) | tetramethylammonium thiocyanate | as per test |
| 726 | (Ig-1) | tetramethylammonium citrate | as per test |
| 727 | (Ig-1) | tetramethylammonium oxalate | as per test |
| 728 | (Ig-1) | tetramethylammonium formate | as per test |
| 729 | (Ig-1) | tetramethylammonium hydrogenphosphate | as per test |
| 730 | (Ig-1) | tetramethylammonium dihydrogenphosphate | as per test |
| 731 | (Ig-1) | tetraethylammonium sulphate | as per test |
| 732 | (Ig-1) | tetraethylammonium lactate | as per test |
| 733 | (Ig-1) | tetraethylammonium nitrate | as per test |
| 734 | (Ig-1) | tetraethylammonium thiosulphate | as per test |
| 735 | (Ig-1) | tetraethylammonium thiocyanate | as per test |
| 736 | (Ig-1) | tetraethylammonium citrate | as per test |
| 737 | (Ig-1) | tetraethylammonium oxalate | as per test |
| 738 | (Ig-1) | tetraethylammonium formate | as per test |
| 739 | (Ig-1) | tetraethylammonium hydrogenphosphate | as per test |
| 740 | (Ig-1) | tetraethylammonium dihydrogenphosphate | as per test |
| 741 | (Ig-2) | ammonium sulphate | as per test |
| 742 | (Ig-2) | ammonium lactate | as per test |
| 743 | (Ig-2) | ammonium nitrate | as per test |
| 744 | (Ig-2) | ammonium thiosulphate | as per test |
| 745 | (Ig-2) | ammonium thiocyanate | as per test |
| 746 | (Ig-2) | ammonium citrate | as per test |
| 747 | (Ig-2) | ammonium oxalate | as per test |
| 748 | (Ig-2) | ammonium formate | as per test |
| 749 | (Ig-2) | ammonium hydrogenphosphate | as per test |
| 750 | (Ig-2) | ammonium dihydrogenphosphate | as per test |
| 751 | (Ig-2) | ammonium carbonate | as per test |
| 752 | (Ig-2) | ammonium benzoate | as per test |
| 753 | (Ig-2) | ammonium sulphite | as per test |
| 754 | (Ig-2) | ammonium benzoate | as per test |
| 755 | (Ig-2) | ammonium hydrogenoxalate | as per test |
| 756 | (Ig-2) | ammonium hydrogencitrate | as per test |
| 757 | (Ig-2) | ammonium acetate | as per test |
| 758 | (Ig-2) | tetramethylammonium sulphate | as per test |
| 759 | (Ig-2) | tetramethylammonium lactate | as per test |
| 760 | (Ig-2) | tetramethylammonium nitrate | as per test |
| 761 | (Ig-2) | tetramethylammonium thiosulphate | as per test |
| 762 | (Ig-2) | tetramethylammonium thiocyanate | as per test |
| 763 | (Ig-2) | tetramethylammonium citrate | as per test |
| 764 | (Ig-2) | tetramethylammonium oxalate | as per test |
| 765 | (Ig-2) | tetramethylammonium formate | as per test |
| 766 | (Ig-2) | tetramethylammonium hydrogenphosphate | as per test |
| 767 | (Ig-2) | tetramethylammonium dihydrogenphosphate | as per test |
| 768 | (Ig-2) | tetraethylammonium sulphate | as per test |
| 769 | (Ig-2) | tetraethylammonium lactate | as per test |
| 770 | (Ig-2) | tetraethylammonium nitrate | as per test |
| 771 | (Ig-2) | tetraethylammonium thiosulphate | as per test |
| 772 | (Ig-2) | tetraethylammonium thiocyanate | as per test |
| 773 | (Ig-2) | tetraethylammonium citrate | as per test |
| 774 | (Ig-2) | tetraethylammonium oxalate | as per test |
| 775 | (Ig-2) | tetraethylammonium formate | as per test |
| 776 | (Ig-2) | tetraethylammonium hydrogenphosphate | as per test |
| 777 | (Ig-2) | tetraethylammonium dihydrogenphosphate | as per test |
| 778 | (Ig-3) | ammonium sulphate | as per test |
| 779 | (Ig-3) | ammonium lactate | as per test |
| 780 | (Ig-3) | ammonium nitrate | as per test |
| 781 | (Ig-3) | ammonium thiosulphate | as per test |
| 782 | (Ig-3) | ammonium thiocyanate | as per test |
| 783 | (Ig-3) | ammonium citrate | as per test |
| 784 | (Ig-3) | ammonium oxalate | as per test |
| 785 | (Ig-3) | ammonium formate | as per test |
| 786 | (Ig-3) | ammonium hydrogenphosphate | as per test |
| 787 | (Ig-3) | ammonium dihydrogenphosphate | as per test |
| 788 | (Ig-3) | ammonium carbonate | as per test |
| 789 | (Ig-3) | ammonium benzoate | as per test |
| 790 | (Ig-3) | ammonium sulphite | as per test |
| 791 | (Ig-3) | ammonium benzoate | as per test |
| 792 | (Ig-3) | ammonium hydrogenoxalate | as per test |
| 793 | (Ig-3) | ammonium hydrogencitrate | as per test |
| 794 | (Ig-3) | ammonium acetate | as per test |
| 795 | (Ig-3) | tetramethylammonium sulphate | as per test |
| 796 | (Ig-3) | tetramethylammonium lactate | as per test |
| 797 | (Ig-3) | tetramethylammonium nitrate | as per test |
| 798 | (Ig-3) | tetramethylammonium thiosulphate | as per test |
| 799 | (Ig-3) | tetramethylammonium thiocyanate | as per test |
| 800 | (Ig-3) | tetramethylammonium citrate | as per test |
| 801 | (Ig-3) | tetramethylammonium oxalate | as per test |
| 802 | (Ig-3) | tetramethylammonium formate | as per test |
| 803 | (Ig-3) | tetramethylammonium hydrogenphosphate | as per test |
| 804 | (Ig-3) | tetramethylammonium dihydrogenphosphate | as per test |
| 805 | (Ig-3) | tetraethylammonium sulphate | as per test |
| 806 | (Ig-3) | tetraethylammonium lactate | as per test |
| 807 | (Ig-3) | tetraethylammonium nitrate | as per test |
| 808 | (Ig-3) | tetraethylammonium thiosulphate | as per test |
| 809 | (Ig-3) | tetraethylammonium thiocyanate | as per test |
| 810 | (Ig-3) | tetraethylammonium citrate | as per test |
| 811 | (Ig-3) | tetraethylammonium oxalate | as per test |
| 812 | (Ig-3) | tetraethylammonium formate | as per test |
| 813 | (Ig-3) | tetraethylammonium hydrogenphosphate | as per test |
| 814 | (Ig-3) | tetraethylammonium dihydrogenphosphate | as per test |
| 815 | (Ig-4) | ammonium sulphate | as per test |
| 816 | (Ig-4) | ammonium lactate | as per test |
| 817 | (Ig-4) | ammonium nitrate | as per test |
| 818 | (Ig-4) | ammonium thiosulphate | as per test |
| 819 | (Ig-4) | ammonium thiocyanate | as per test |
| 820 | (Ig-4) | ammonium citrate | as per test |
| 821 | (Ig-4) | ammonium oxalate | as per test |
| 822 | (Ig-4) | ammonium formate | as per test |
| 823 | (Ig-4) | ammonium hydrogenphosphate | as per test |
| 824 | (Ig-4) | ammonium dihydrogenphosphate | as per test |
| 825 | (Ig-4) | ammonium carbonate | as per test |
| 826 | (Ig-4) | ammonium benzoate | as per test |
| 827 | (Ig-4) | ammonium sulphite | as per test |
| 828 | (Ig-4) | ammonium benzoate | as per test |
| 829 | (Ig-4) | ammonium hydrogenoxalate | as per test |
| 830 | (Ig-4) | ammonium hydrogencitrate | as per test |
| 831 | (Ig-4) | ammonium acetate | as per test |
| 832 | (Ig-4) | tetramethylammonium sulphate | as per test |
| 833 | (Ig-4) | tetramethylammonium lactate | as per test |
| 834 | (Ig-4) | tetramethylammonium nitrate | as per test |
| 835 | (Ig-4) | tetramethylammonium thiosulphate | as per test |
| 836 | (Ig-4) | tetramethylammonium thiocyanate | as per test |
| 837 | (Ig-4) | tetramethylammonium citrate | as per test |
| 838 | (Ig-4) | tetramethylammonium oxalate | as per test |
| 839 | (Ig-4) | tetramethylammonium formate | as per test |
| 840 | (Ig-4) | tetramethylammonium hydrogenphosphate | as per test |
| 841 | (Ig-4) | tetramethylammonium dihydrogenphosphate | as per test |
| 842 | (Ig-4) | tetraethylammonium sulphate | as per test |
| 843 | (Ig-4) | tetraethylammonium lactate | as per test |
| 844 | (Ig-4) | tetraethylammonium nitrate | as per test |
| 845 | (Ig-4) | tetraethylammonium thiosulphate | as per test |
| 846 | (Ig-4) | tetraethylammonium thiocyanate | as per test |
| 847 | (Ig-4) | tetraethylammonium citrate | as per test |
| 848 | (Ig-4) | tetraethylammonium oxalate | as per test |
| 849 | (Ig-4) | tetraethylammonium formate | as per test |
| 850 | (Ig-4) | tetraethylammonium hydrogenphosphate | as per test |
| 851 | (Ig-4) | tetraethylammonium dihydrogenphosphate | as per test |
| 852 | (Ig-5) | ammonium sulphate | as per test |
| 853 | (Ig-5) | ammonium lactate | as per test |
| 854 | (Ig-5) | ammonium nitrate | as per test |
| 855 | (Ig-5) | ammonium thiosulphate | as per test |
| 856 | (Ig-5) | ammonium thiocyanate | as per test |
| 857 | (Ig-5) | ammonium citrate | as per test |
| 858 | (Ig-5) | ammonium oxalate | as per test |
| 859 | (Ig-5) | ammonium formate | as per test |
| 860 | (Ig-5) | ammonium hydrogenphosphate | as per test |
| 861 | (Ig-5) | ammonium dihydrogenphosphate | as per test |
| 862 | (Ig-5) | ammonium carbonate | as per test |
| 863 | (Ig-5) | ammonium benzoate | as per test |
| 864 | (Ig-5) | ammonium sulphite | as per test |
| 865 | (Ig-5) | ammonium benzoate | as per test |
| 866 | (Ig-5) | ammonium hydrogenoxalate | as per test |
| 867 | (Ig-5) | ammonium hydrogencitrate | as per test |
| 868 | (Ig-5) | ammonium acetate | as per test |
| 869 | (Ig-5) | tetramethylammonium sulphate | as per test |
| 870 | (Ig-5) | tetramethylammonium lactate | as per test |
| 871 | (Ig-5) | tetramethylammonium nitrate | as per test |
| 872 | (Ig-5) | tetramethylammonium thiosulphate | as per test |
| 873 | (Ig-5) | tetramethylammonium thiocyanate | as per test |
| 874 | (Ig-5) | tetramethylammonium citrate | as per test |
| 875 | (Ig-5) | tetramethylammonium oxalate | as per test |
| 876 | (Ig-5) | tetramethylammonium formate | as per test |
| 877 | (Ig-5) | tetramethylammonium hydrogenphosphate | as per test |
| 878 | (Ig-5) | tetramethylammonium dihydrogenphosphate | as per test |
| 879 | (Ig-5) | tetraethylammonium sulphate | as per test |
| 880 | (Ig-5) | tetraethylammonium lactate | as per test |
| 881 | (Ig-5) | tetraethylammonium nitrate | as per test |
| 882 | (Ig-5) | tetraethylammonium thiosulphate | as per test |
| 883 | (Ig-5) | tetraethylammonium thiocyanate | as per test |
| 884 | (Ig-5) | tetraethylammonium citrate | as per test |
| 885 | (Ig-5) | tetraethylammonium oxalate | as per test |
| 886 | (Ig-5) | tetraethylammonium formate | as per test |
| 887 | (Ig-5) | tetraethylammonium hydrogenphosphate | as per test |
| 888 | (Ig-5) | tetraethylammonium dihydrogenphosphate | as per test |
| 889 | (Ih-1) | ammonium sulphate | as per test |
| 890 | (Ih-1) | ammonium lactate | as per test |
| 891 | (Ih-1) | ammonium nitrate | as per test |
| 892 | (Ih-1) | ammonium thiosulphate | as per test |
| 893 | (Ih-1) | ammonium thiocyanate | as per test |
| 894 | (Ih-1) | ammonium citrate | as per test |
| 895 | (Ih-1) | ammonium oxalate | as per test |
| 896 | (Ih-1) | ammonium formate | as per test |
| 897 | (Ih-1) | ammonium hydrogenphosphate | as per test |
| 898 | (Ih-1) | ammonium dihydrogenphosphate | as per test |
| 899 | (Ih-1) | ammonium carbonate | as per test |
| 900 | (Ih-1) | ammonium benzoate | as per test |
| 901 | (Ih-1) | ammonium sulphite | as per test |
| 902 | (Ih-1) | ammonium benzoate | as per test |
| 903 | (Ih-1) | ammonium hydrogenoxalate | as per test |
| 904 | (Ih-1) | ammonium hydrogencitrate | as per test |
| 905 | (Ih-1) | ammonium acetate | as per test |
| 906 | (Ih-1) | tetramethylammonium sulphate | as per test |
| 907 | (Ih-1) | tetramethylammonium lactate | as per test |
| 908 | (Ih-1) | tetramethylammonium nitrate | as per test |
| 909 | (Ih-1) | tetramethylammonium thiosulphate | as per test |
| 910 | (Ih-1) | tetramethylammonium thiocyanate | as per test |
| 911 | (Ih-1) | tetramethylammonium citrate | as per test |
| 912 | (Ih-1) | tetramethylammonium oxalate | as per test |
| 913 | (Ih-1) | tetramethylammonium formate | as per test |
| 914 | (Ih-1) | tetramethylammonium hydrogenphosphate | as per test |
| 915 | (Ih-1) | tetramethylammonium dihydrogenphosphate | as per test |
| 916 | (Ih-1) | tetraethylammonium sulphate | as per test |
| 917 | (Ih-1) | tetraethylammonium lactate | as per test |
| 918 | (Ih-1) | tetraethylammonium nitrate | as per test |
| 919 | (Ih-1) | tetraethylammonium thiosulphate | as per test |
| 920 | (Ih-1) | tetraethylammonium thiocyanate | as per test |
| 921 | (Ih-1) | tetraethylammonium citrate | as per test |
| 922 | (Ih-1) | tetraethylammonium oxalate | as per test |
| 923 | (Ih-1) | tetraethylammonium formate | as per test |
| 924 | (Ih-1) | tetraethylammonium hydrogenphosphate | as per test |
| 925 | (Ih-1) | tetraethylammonium dihydrogenphosphate | as per test |
| 926 | (Ih-2) | ammonium sulphate | as per test |
| 927 | (Ih-2) | ammonium lactate | as per test |
| 928 | (Ih-2) | ammonium nitrate | as per test |
| 929 | (Ih-2) | ammonium thiosulphate | as per test |
| 930 | (Ih-2) | ammonium thiocyanate | as per test |
| 931 | (Ih-2) | ammonium citrate | as per test |
| 932 | (Ih-2) | ammonium oxalate | as per test |
| 933 | (Ih-2) | ammonium formate | as per test |
| 934 | (Ih-2) | ammonium hydrogenphosphate | as per test |
| 935 | (Ih-2) | ammonium dihydrogenphosphate | as per test |
| 936 | (Ih-2) | ammonium carbonate | as per test |
| 937 | (Ih-2) | ammonium benzoate | as per test |
| 938 | (Ih-2) | ammonium sulphite | as per test |
| 939 | (Ih-2) | ammonium benzoate | as per test |
| 940 | (Ih-2) | ammonium hydrogenoxalate | as per test |
| 941 | (Ih-2) | ammonium hydrogencitrate | as per test |
| 942 | (Ih-2) | ammonium acetate | as per test |
| 943 | (Ih-2) | tetramethylammonium sulphate | as per test |
| 944 | (Ih-2) | tetramethylammonium lactate | as per test |
| 945 | (Ih-2) | tetramethylammonium nitrate | as per test |
| 946 | (Ih-2) | tetramethylammonium thiosulphate | as per test |
| 947 | (Ih-2) | tetramethylammonium thiocyanate | as per test |
| 948 | (Ih-2) | tetramethylammonium citrate | as per test |
| 949 | (Ih-2) | tetramethylammonium oxalate | as per test |
| 950 | (Ih-2) | tetramethylammonium formate | as per test |
| 951 | (Ih-2) | tetramethylammonium hydrogenphosphate | as per test |
| 952 | (Ih-2) | tetramethylammonium dihydrogenphosphate | as per test |
| 953 | (Ih-2) | tetraethylammonium sulphate | as per test |
| 954 | (Ih-2) | tetraethylammonium lactate | as per test |
| 955 | (Ih-2) | tetraethylammonium nitrate | as per test |
| 956 | (Ih-2) | tetraethylammonium thiosulphate | as per test |
| 957 | (Ih-2) | tetraethylammonium thiocyanate | as per test |
| 958 | (Ih-2) | tetraethylammonium citrate | as per test |
| 959 | (Ih-2) | tetraethylammonium oxalate | as per test |
| 960 | (Ih-2) | tetraethylammonium formate | as per test |
| 961 | (Ih-2) | tetraethylammonium hydrogenphosphate | as per test |
| 962 | (Ih-2) | tetraethylammonium dihydrogenphosphate | as per test |
| 963 | (Ih-3) | ammonium sulphate | as per test |
| 964 | (Ih-3) | ammonium lactate | as per test |
| 965 | (Ih-3) | ammonium nitrate | as per test |
| 966 | (Ih-3) | ammonium thiosulphate | as per test |
| 967 | (Ih-3) | ammonium thiocyanate | as per test |
| 968 | (Ih-3) | ammonium citrate | as per test |
| 969 | (Ih-3) | ammonium oxalate | as per test |
| 970 | (Ih-3) | ammonium formate | as per test |
| 971 | (Ih-3) | ammonium hydrogenphosphate | as per test |
| 972 | (Ih-3) | ammonium dihydrogenphosphate | as per test |
| 973 | (Ih-3) | ammonium carbonate | as per test |
| 974 | (Ih-3) | ammonium benzoate | as per test |
| 975 | (Ih-3) | ammonium sulphite | as per test |
| 976 | (Ih-3) | ammonium benzoate | as per test |
| 977 | (Ih-3) | ammonium hydrogenoxalate | as per test |
| 978 | (Ih-3) | ammonium hydrogencitrate | as per test |
| 979 | (Ih-3) | ammonium acetate | as per test |
| 980 | (Ih-3) | tetramethylammonium sulphate | as per test |
| 981 | (Ih-3) | tetramethylammonium lactate | as per test |
| 982 | (Ih-3) | tetramethylammonium nitrate | as per test |
| 983 | (Ih-3) | tetramethylammonium thiosulphate | as per test |
| 984 | (Ih-3) | tetramethylammonium thiocyanate | as per test |
| 985 | (Ih-3) | tetramethylammonium citrate | as per test |
| 986 | (Ih-3) | tetramethylammonium oxalate | as per test |
| 987 | (Ih-3) | tetramethylammonium formate | as per test |
| 988 | (Ih-3) | tetramethylammonium hydrogenphosphate | as per test |
| 989 | (Ih-3) | tetramethylammonium dihydrogenphosphate | as per test |
| 990 | (Ih-3) | tetraethylammonium sulphate | as per test |
| 991 | (Ih-3) | tetraethylammonium lactate | as per test |
| 992 | (Ih-3) | tetraethylammonium nitrate | as per test |
| 993 | (Ih-3) | tetraethylammonium thiosulphate | as per test |
| 994 | (Ih-3) | tetraethylammonium thiocyanate | as per test |
| 995 | (Ih-3) | tetraethylammonium citrate | as per test |
| 996 | (Ih-3) | tetraethylammonium oxalate | as per test |
| 997 | (Ih-3) | tetraethylammonium formate | as per test |
| 998 | (Ih-3) | tetraethylammonium hydrogenphosphate | as per test |
| 999 | (Ih-3) | tetraethylammonium dihydrogenphosphate | as per test |
| 1000 | (Ih-4) | ammonium sulphate | as per test |
| 1001 | (Ih-4) | ammonium lactate | as per test |
| 1002 | (Ih-4) | ammonium nitrate | as per test |
| 1003 | (Ih-4) | ammonium thiosulphate | as per test |
| 1004 | (Ih-4) | ammonium thiocyanate | as per test |
| 1005 | (Ih-4) | ammonium citrate | as per test |
| 1006 | (Ih-4) | ammonium oxalate | as per test |
| 1007 | (Ih-4) | ammonium formate | as per test |
| 1008 | (Ih-4) | ammonium hydrogenphosphate | as per test |
| 1009 | (Ih-4) | ammonium dihydrogenphosphate | as per test |
| 1010 | (Ih-4) | ammonium carbonate | as per test |
| 1011 | (Ih-4) | ammonium benzoate | as per test |
| 1012 | (Ih-4) | ammonium sulphite | as per test |
| 1013 | (Ih-4) | ammonium benzoate | as per test |
| 1014 | (Ih-4) | ammonium hydrogenoxalate | as per test |
| 1015 | (Ih-4) | ammonium hydrogencitrate | as per test |
| 1016 | (Ih-4) | ammonium acetate | as per test |
| 1017 | (Ih-4) | tetramethylammonium sulphate | as per test |
| 1018 | (Ih-4) | tetramethylammonium lactate | as per test |
| 1019 | (Ih-4) | tetramethylammonium nitrate | as per test |
| 1020 | (Ih-4) | tetramethylammonium thiosulphate | as per test |
| 1021 | (Ih-4) | tetramethylammonium thiocyanate | as per test |
| 1022 | (Ih-4) | tetramethylammonium citrate | as per test |
| 1023 | (Ih-4) | tetramethylammonium oxalate | as per test |
| 1024 | (Ih-4) | tetramethylammonium formate | as per test |
| 1025 | (Ih-4) | tetramethylammonium hydrogenphosphate | as per test |
| 1026 | (Ih-4) | tetramethylammonium dihydrogenphosphate | as per test |
| 1027 | (Ih-4) | tetraethylammonium sulphate | as per test |
| 1028 | (Ih-4) | tetraethylammonium lactate | as per test |
| 1029 | (Ih-4) | tetraethylammonium nitrate | as per test |
| 1030 | (Ih-4) | tetraethylammonium thiosulphate | as per test |
| 1031 | (Ih-4) | tetraethylammonium thiocyanate | as per test |
| 1032 | (Ih-4) | tetraethylammonium citrate | as per test |
| 1033 | (Ih-4) | tetraethylammonium oxalate | as per test |
| 1034 | (Ih-4) | tetraethylammonium formate | as per test |
| 1035 | (Ih-4) | tetraethylammonium hydrogenphosphate | as per test |
| 1036 | (Ih-4) | tetraethylammonium dihydrogenphosphate | as per test |
| 1037 | (Ih-5) | ammonium sulphate | as per test |
| 1038 | (Ih-5) | ammonium lactate | as per test |
| 1039 | (Ih-5) | ammonium nitrate | as per test |
| 1040 | (Ih-5) | ammonium thiosulphate | as per test |
| 1041 | (Ih-5) | ammonium thiocyanate | as per test |
| 1042 | (Ih-5) | ammonium citrate | as per test |
| 1043 | (Ih-5) | ammonium oxalate | as per test |
| 1044 | (Ih-5) | ammonium formate | as per test |
| 1045 | (Ih-5) | ammonium hydrogenphosphate | as per test |
| 1046 | (Ih-5) | ammonium dihydrogenphosphate | as per test |
| 1047 | (Ih-5) | ammonium carbonate | as per test |
| 1048 | (Ih-5) | ammonium benzoate | as per test |
| 1049 | (Ih-5) | ammonium sulphite | as per test |
| 1050 | (Ih-5) | ammonium benzoate | as per test |
| 1051 | (Ih-5) | ammonium hydrogenoxalate | as per test |
| 1052 | (Ih-5) | ammonium hydrogencitrate | as per test |
| 1053 | (Ih-5) | ammonium acetate | as per test |
| 1054 | (Ih-5) | tetramethylammonium sulphate | as per test |
| 1055 | (Ih-5) | tetramethylammonium lactate | as per test |
| 1056 | (Ih-5) | tetramethylammonium nitrate | as per test |
| 1057 | (Ih-5) | tetramethylammonium thiosulphate | as per test |
| 1058 | (Ih-5) | tetramethylammonium thiocyanate | as per test |
| 1059 | (Ih-5) | tetramethylammonium citrate | as per test |
| 1060 | (Ih-5) | tetramethylammonium oxalate | as per test |
| 1061 | (Ih-5) | tetramethylammonium formate | as per test |
| 1062 | (Ih-5) | tetramethylammonium hydrogenphosphate | as per test |
| 1063 | (Ih-5) | tetramethylammonium dihydrogenphosphate | as per test |
| 1064 | (Ih-5) | tetraethylammonium sulphate | as per test |
| 1065 | (Ih-5) | tetraethylammonium lactate | as per test |
| 1066 | (Ih-5) | tetraethylammonium nitrate | as per test |
| 1067 | (Ih-5) | tetraethylammonium thiosulphate | as per test |
| 1068 | (Ih-5) | tetraethylammonium thiocyanate | as per test |
| 1069 | (Ih-5) | tetraethylammonium citrate | as per test |
| 1070 | (Ih-5) | tetraethylammonium oxalate | as per test |
| 1071 | (Ih-5) | tetraethylammonium formate | as per test |
| 1072 | (Ih-5) | tetraethylammonium hydrogenphosphate | as per test |
| 1073 | (Ih-5) | tetraethylammonium dihydrogenphosphate | as per test |

Crop protection compositions according to the invention may also comprise further components, for example, surfactants and/or dispersing auxiliaries or emulsifiers.

Suitable nonionic surfactants and/or dispersing auxiliaries include all substances of this type that can usually be used in agrochemical compositions. Polyethylene oxide/polypropylene oxide block copolymers, polyethylene glycol ethers of straight-chain alcohols, reaction products of fatty acids with ethylene oxide and/or propylene oxide, furthermore polyvinyl alcohol, polyvinyl pyrrolidone, copolymers of polyvinyl alcohol and polyvinyl pyrrolidone and copolymers of (meth)acrylic acid and (meth)acrylic esters, and additionally alkyl ethoxylates and alkylaryl ethoxylates, which optionally may be phosphated and optionally may be neutralized with bases, examples of which may be mentioned being sorbitol ethoxylates, and also polyoxyalkyleneamine derivatives may be mentioned as being preferred.

Suitable anionic surfactants are all substances of this type that can usually be used in agrochemical compositions. Preference is given to alkali metal salts and alkaline earth metal salts of alkylsulphonic acids or alkylarylsulphonic acids.

A further preferred group of anionic surfactants and/or dispersing auxiliaries are the following salts that are of low solubility in plant oil: salts of polystyrenesulphonic acids, salts of polyvinylsulphonic acids, salts of naphthalenesulphonic acid/formaldehyde condensation products, salts of condensation products of naphthalenesulphonic acid, phenolsulphonic acid and formaldehyde, and salts of lignosulphonic acid.

Suitable additives which may be included in the formulations according to the invention are emulsifiers, foam inhibitors, preservatives, antioxidants, colorants and inert filling materials.

Preferred emulsifiers are ethoxylated nonylphenols, reaction products of alkylphenols with ethylene oxide and/or propylene oxide, ethoxylated arylalkylphenols, and also ethoxylated and propoxylated arylalkylphenols, and also sulphated or phosphated arylalkyl ethoxylates and/or arylalkyl ethoxypropoxylates, mention being made by way of example of sorbitan derivatives, such as polyethylene oxide sorbitan fatty acid esters and sorbitan fatty acid esters.

The examples below serve to illustrate the invention and should in no way be interpreted as being restrictive.

### Activity Increase Through Ammonium Salts/Phosphonium Salts

The activity increase through ammonium salts or phosphonium salts is evident from the examples below. Whereas the salts alone, at the application rates employed, have no insecticidal activity, they effect a considerable activity increase as additives for insecticidally active compounds.

### EXAMPLE A

Aphis gossypii test

| | |
|---|---|
| Solvent: | 7 parts by weight of dimethylformamide |
| Emulsifier: | 1 part by weight of alkylaryl polyglycol ether |

To produce a suitable preparation of active compound, 1 part by weight of active compound is mixed with the stated amounts of solvent and emulsifier, and the concentrate is diluted with water to the desired concentration. If addition of ammonium salts, phosphonium salts or penetrants is required, the appropriate amount is added by pipette after dilution of the respective finished preparation solution.

Single-leaf cotton plants (Gossypium hirsutum) which are heavily infested by the cotton aphid (Aphis gossypii) are treated by spraying of the upper side of the leaf (spray volume 600 l/ha) with the active compound preparation at the desired concentration.

After the desired period of time, the kill in % is determined. 100% means that all animals have been killed; 0% means that none of the animals have been killed.

Kill rate after
3 days

| | Active | | With |
|---|---|---|---|
| Active | compound | Without | AS |
| compound | g/ha | AS | 1 g/l |
| (Ib-3) | 24 | 77 | 99 |

AS = ammonium sulphate

Activity Increase by Ammonium Salts/Phosphonium Salts in Combination with Penetrants

The data below confirm that ammonium salts or phosphonium salts are capable of increasing the activity even more, even when ready-to-use crop protection compositions comprising penetrants to increase activity are applied.

### EXAMPLE B

Myzus persicae test

| | |
|---|---|
| Solvent: | 7 parts by weight of dimethylformamide |
| Emulsifier: | 1 part by weight of alkylaryl polyglycol ether |

To produce a suitable preparation of active compound, 1 part by weight of active compound is mixed with the stated amounts of solvent and emulsifier, and the concentrate is diluted with water to the desired concentration. If addition of ammonium salts, phosphonium salts or penetrants is required, the appropriate amount is added by pipette after dilution of the respective finished preparation solution. Single-leaf bell pepper plants (Capsicum annuum) which are heavily infested by the green peach aphid (Myzus persicaei) are treated by spraying of the upper side of the leaf (spray volume 600 l/ha) with the active compound preparation at the desired concentration. After the desired period of time, the kill in % is determined. 100% means that all animals have been killed; 0% means that none of the animals have been killed.

Kill rate after
6 days

| | Active | | With |
|---|---|---|---|
| | compound | Without | AS |
| Formulation | g/ha | AS | 1 g/l |
| (Ib-3) + RME (1 g/l) | 4.8 | 60 | 83 |

RME = rapeseed oil methyl ester (amount formulated as 500 EW; concentration stated in g of active compound/l)
AS = ammonium sulphate

### EXAMPLE C

Aphis gossypii test

| | |
|---|---|
| Solvent: | 7 parts by weight of dimethylformamide |
| Emulsifier: | 1 part by weight of alkylaryl polyglycol ether |

To produce a suitable preparation of active compound, 1 part by weight of active compound is mixed with the stated amounts of solvent and emulsifier, and the concentrate is diluted with water to the desired concentration. If addition of ammonium salts, phosphonium salts or penetrants is required, the appropriate amount is added by pipette after dilution of the respective finished preparation solution.

Single-leaf cotton plants (Gossypium hirsutum) which are heavily infested by the cotton aphid (Aphis gossypii) are treated by spraying of the upper side of the leaf (spray volume 600 l/ha) with the active compound preparation at the desired concentration.

After the desired period of time, the kill in % is determined. 100% means that all animals have been killed; 0% means that none of the animals have been killed.

Kill rate after
6 days

| | Active | | With |
|---|---|---|---|
| | compound | Without | AS |
| Active compound | g/ha | AS | 1 g/l |
| (Ib-3) + RME (1 g/l) | 4.8 | 83 | 96 |

RME = rapeseed oil methyl ester (amount formulated as 500 EW; concentration stated in g of active compound/l)
AS = ammonium sulphate

### EXAMPLE D

Myzus persicae test

| | |
|---|---|
| Solvent: | 7 parts by weight of dimethylformamide |
| Emulsifier: | 2 parts by weight of alkylaryl polyglycol ether |

To produce a suitable preparation of active compound, 1 part by weight of active compound is mixed with the stated amounts of solvent and emulsifier, and the concentrate is diluted with emulsifier-containing water to the desired concentration. If addition of ammonium salts or ammonium salts and penetrant is required, the appropriate amount is added by pipette after dilution of the respective finished preparation solution (in each case 1000 ppm).

Bell pepper plants (Capsicum annuum) which are heavily infested by the green peach aphid (Myzus persicaei) are treated by spraying with the active compound preparation at the desired concentration.

After the desired period of time, the kill in % is determined. 100% means that all animals have been killed; 0% means that none of the animals have been killed.

In this test, for example, the following compounds of the preparation examples show good activity: see table

| | | Kill rate | |
|---|---|---|---|
| | Active | after 6 days | |
| | compound | Without penetrant | With penetrant and |
| Active compound | ppm | and AS | AS |
| Ia-1 | 0.16 | 10 | 85 |
| Ia-2 | 0.8 | 60 | 100 |
| Ia-3 | 0.16 | 0 | 50 |
| Ia-4 | 4 | 10 | 80 |
| Ia-5 | 0.16 | 0 | 90 |
| Ia-6 | 0.8 | 10 | 90 |
| Ia-7 | 4 | 40 | 100 |
| Ia-9 | 0.8 | 70 | 100 |
| Ic-1 | 0.8 | 0 | 95 |
| Id-1 | 0.8 | 0 | 90 |
| Ie-2 | 0.16 | 10 | 95 |
| If-1 | 0.16 | 20 | 85 |
| If-2 | 0.16 | 0 | 50 |
| Ih-1 | 0.8 | 20 | 98 |
| Ih-2 | 0.8 | 80 | 98 |

### EXAMPLE E

Aphis gossypii test

| | |
|---|---|
| Solvent: | 7 parts by weight of dimethylformamide |
| Emulsifier: | 2 parts by weight of alkylaryl polyglycol ether |

To produce a suitable preparation of active compound, 1 part by weight of active compound is mixed with the stated amounts of solvent and emulsifier, and the concentrate is diluted with emulsifier-containing water to the desired concentration. If addition of ammonium salts or ammonium salts and penetrant is required, the appropriate amount is added by pipette after dilution of the respective finished preparation solution (in each case 1000 ppm).

Cotton leaves (Gossypium hirsutum) which are heavily infested by the cotton aphid (Aphis gossypii) are sprayed with an active compound preparation at the desired concentration.

After the desired period of time, the kill in % is determined. 100% means that all aphids have been killed; 0% means that none of the aphids have been killed.

In this test, for example, the following compounds show good activity: see table

| | | Kill rate | |
|---|---|---|---|
| | Active | after 6 days | |
| | compound | Without penetrant | With penetrant and |
| Active compound | ppm | and AS | AS |
| Ia-1 | 0.16 | 0 | 40 |
| Ia-3 | 0.16 | 0 | 70 |
| Ia-4 | 0.8 | 0 | 35 |
| Ia-6 | 0.8 | 25 | 99 |
| Ia-7 | 4 | 15 | 95 |
| Ia-8 | 0.8 | 65 | 95 |
| Ia-9 | 0.8 | 80 | 100 |
| Ic-1 | 0.8 | 5 | 60 |
| Id-1 | 0.8 | 0 | 55 |
| Ie-2 | 0.16 | 10 | 95 |
| If-1 | 0.16 | 30 | 75 |
| If-2 | 0.16 | 0 | 50 |
| Ih-1 | 0.8 | 5 | 95 |
| Ih-2 | 0.8 | 65 | 90 |
| Ih-3 | 0.8 | 15 | 55 |
| Ih-4 | 0.8 | 15 | 45 |

### EXAMPLE F

Myzus persicae test

| | |
|---|---|
| Solvent: | 7 parts by weight of dimethylformamide |
| Emulsifier: | 1 part by weight of alkylaryl polyglycol ether |

To produce a suitable preparation of active compound, 1 part by weight of active compound is mixed with the stated amounts of solvent and emulsifier, and the concentrate is diluted with water to the desired concentration. If addition of ammonium salts or ammonium salts and penetrant is required, the appropriate amount is added by pipette after dilution of the respective finished preparation solution (in each case 1000 ppm).

Single-leaf bell pepper plants (Capsicum annuum) which are heavily infested by the green peach aphid (Myzus persicaei) are treated by spraying of the underside of the leaf with the active compound preparation at the desired concentration.

After the desired period of time, the kill in % is determined. 100% means that all animals have been killed; 0% means that none of the animals have been killed.

In this test, for example, the following compounds show good activity: see table

| | | Kill rate | |
|---|---|---|---|
| | Active | after 7 days | |
| | compound | Without penetrant | With penetrant and |
| Active compound | g/ha | and AS | AS |
| Ic-1 | 0.48 | 0 | 67 |

### EXAMPLE G

Myzus persicae test

| | |
|---|---|
| Solvent: | 7 parts by weight of dimethylformamide |
| Emulsifier: | 1 part by weight of alkylaryl polyglycol ether |

To produce a suitable preparation of active compound, 1 part by weight of active compound is mixed with the stated amounts of solvent and emulsifier, and the concentrate is diluted with water to the desired concentration. If addition of ammonium salts or ammonium salts and penetrant is required, the appropriate amount is added by pipette after dilution of the respective finished preparation solution (in each case 1000 ppm).

Single-leaf bell pepper plants (Capsicum annuum) which are heavily infested by the green peach aphid (Myzus persicaei) are treated by spraying of the upper side of the leaf with the active compound preparation at the desired concentration.

After the desired period of time, the kill in % is determined. 100% means that all animals have been killed; 0% means that none of the animals have been killed.

In this test, for example, the following compounds of the preparation examples show good activity: see table

| | | Kill rate | |
|---|---|---|---|
| | Active | after 7 days | |
| | compound | Without penetrant | With penetrant and |
| Active compound | g/ha | and AS | AS |
| Ic-1 | 2.4 | 0 | 53 |

### EXAMPLE H

Aphis gossypii test (APHIGO contact)

| | |
|---|---|
| Solvent: | 7 parts by weight of dimethylformamide |
| Emulsifier: | 1 part by weight of alkylaryl polyglycol ether |

To produce a suitable preparation of active compound, 1 part by weight of active compound is mixed with the stated amounts of solvent and emulsifier, and the concentrate is diluted with water to the desired concentration. If addition of ammonium salts or ammonium salts and penetrant is required, the appropriate amount is added by pipette after dilution of the respective finished preparation solution (in each case 1000 ppm).

Single-leaf cotton plants (Gossypium hirsutum) which are heavily infested by the cotton aphid (Aphis gossypii) are treated by spraying of the underside of the leaf with the active compound preparation at the desired concentration.

After the desired period of time, the kill in % is determined. 100% means that all animals have been killed; 0% means that none of the animals have been killed.

In this test, for example, the following compounds show good activity: see table

| | | Kill rate | |
|---|---|---|---|
| | Active | after 7 days | |
| | compound | Without penetrant | With penetrant and |
| Active compound | g/ha | and AS | AS |
| Ic-1 | 0.192 | 0 | 70 |

### EXAMPLE I

Aphis gossypii test (APHIGO translaminar)

| | |
|---|---|
| Solvent: | 7 parts by weight of dimethylformamide |
| Emulsifier: | 1 part by weight of alkylaryl polyglycol ether |

To produce a suitable preparation of active compound, 1 part by weight of active compound is mixed with the stated amounts of solvent and emulsifier, and the concentrate is diluted with water to the desired concentration. If addition of ammonium salts or ammonium salts and penetrant is required, the appropriate amount is added by pipette after dilution of the respective finished preparation solution (in each case 1000 ppm).

Single-leaf cotton plants (Gossypium hirsutum) which are heavily infested by the cotton aphid (Aphis gossypii) are treated by spraying of the upper side of the leaf with the active compound preparation at the desired concentration.

After the desired period of time, the kill in % is determined. 100% means that all animals have been killed; 0% means that none of the animals have been killed.

In this test, for example, the following compounds show good activity: see table

| | | Kill rate | |
|---|---|---|---|
| | Active | after 7 days | |
| | compound | Without penetrant | With penetrant and |
| Active compound | g/ha | and AS | AS |
| If-1 | 0.192 | 0 | 70 |

1. Composition comprising
at least one insecticidally or acaricidally active compound
at least one salt of the formula (II) 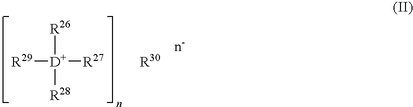
in which
D represents nitrogen or phosphorus,
R²⁶, R²⁷, R²⁸ and R²⁹ independently of one another represent hydrogen or in each case optionally substituted C₁-C₈-alkyl or mono- or polyunsaturated, optionally substituted C₁-C₈-alkylene, where the substituents may be selected from the group consisting of halogen, nitro and cyano,
n represents 1, 2, 3 or 4,
R³⁰ represents an inorganic or organic anion.

2. Composition according to claim 1, wherein the active compound is an inhibitor of a nicotinic acetylcholine receptor.

3. Composition according to claim 1, wherein the active compound is a neonicotinoid.

4. Composition according to claim 1, wherein the active compound is at least one selected from the group consisting of:
thiamethoxam
clothianidin
thiacloprid
dinotefuran
acetamiprid
nitenpyram
imidacloprid
imidaclothiz
AKD-1022

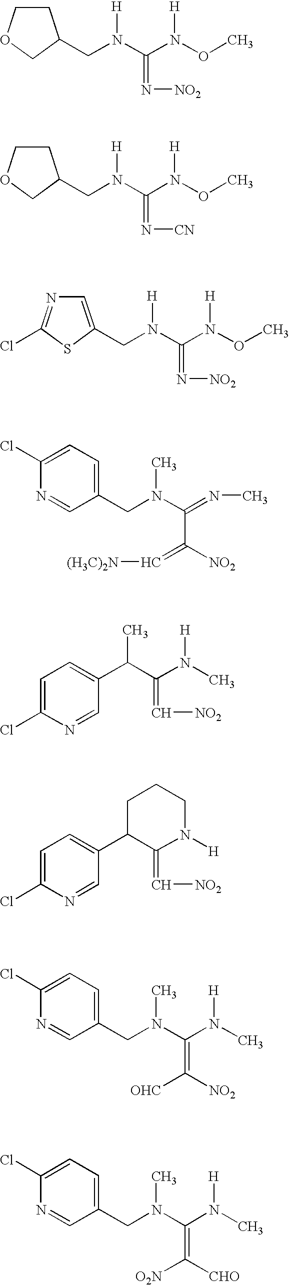

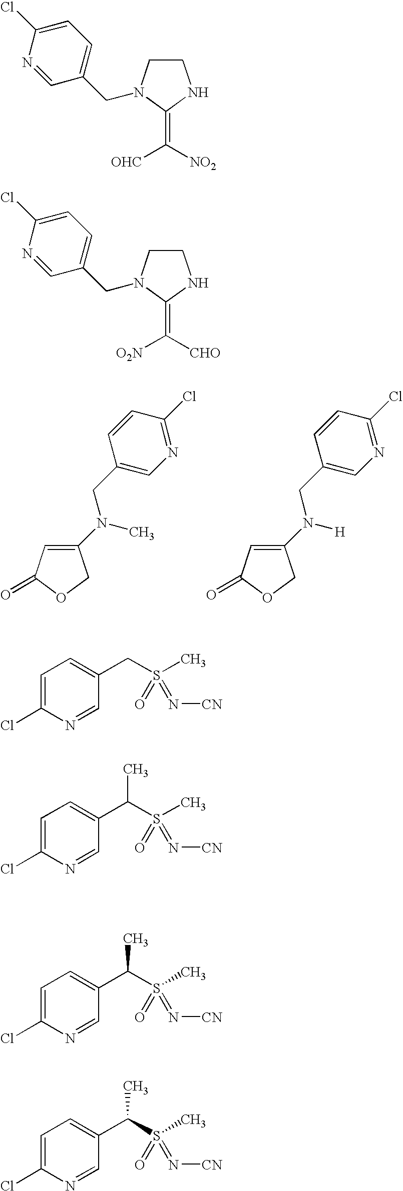

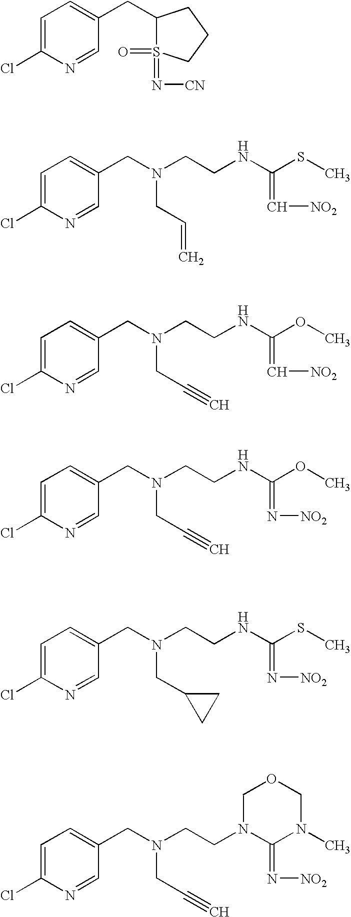

5. Composition according to claim 1, wherein the active compound content is from 0.5 to 50% by weight.

6. Composition according to claim 1, wherein D represents nitrogen.

7. Composition according to claim 6, wherein R³⁰ represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate.

8. Composition according to claim 6, wherein R³⁰ represents carbonate, pentaborate, sulphite, benzoate, hydrogenoxalate, hydrogencitrate, methylsulphate or tetrafluoroborate.

9. Composition according to claim 6, wherein R³⁰ represents lactate, sulphate, nitrate, thiosulphate, thiocyanate, citrate, oxalate or formate.

10. Composition according to claim 6, wherein R³⁰ represents sulphate.

11. Composition according to claim 6, wherein the salt of the formula (II) is ammonium sulphate.

12. Composition according to claim 1, further comprising at least one penetrant.

13. Composition according to claim 12, wherein the penetrant is i) a fatty alcohol alkoxylate of the formula (III)
R—O—(-AO)ᵥ—R′ (III)
in which
R represents straight-chain or branched alkyl having 4 to 20 carbon atoms,
R′ represents hydrogen, methyl, ethyl, n-propyl, isopropyl, n-butyl, isobutyl, t-butyl, n-pentyl or n-hexyl,
AO represents an ethylene oxide radical, a propylene oxide radical, a butylene oxide radical or represents mixtures of ethylene oxide and propylene oxide radicals or butylene oxide radicals and
v represents numbers from 2 to 30,
and/or ii) a mineral or vegetable oil and/or iii) an ester of a mineral or vegetable oil.

14. Composition according to claim 12, wherein the penetrant is an ester of a vegetable oil.

15. Composition according to claim 12, wherein the penetrant is rapeseed oil methyl ester.

16. Composition according to claim 12, wherein the content of penetrant is from 1 to 95% by weight.

17. A method for controlling harmful insects, comprising applying a composition according to claim 1, diluted or undiluted, to an insect or a habitat thereof in such an amount that an effective amount of an insecticidally active compound contained therein acts on the insect or said habitat.

18. Method of increasing the activity of a crop protection composition comprising a neonicotinoid active compound, said method comprising forming a ready-to-use spray liquid composition using a salt of the formula (II) 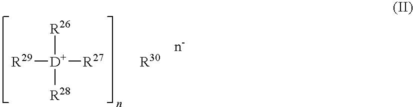
in which
D represents nitrogen or phosphorus,
R²⁶, R²⁷, R²⁸ and R²⁹ independently of one another represent hydrogen or in each case optionally substituted C₁-C₈-alkyl or mono- or polyunsaturated, optionally substituted C₁-C₈-alkylene, where the substituents may be selected from the group consisting of halogen, nitro and cyano,
n represents 1, 2, 3 or 4,
R³⁰ represents an inorganic or organic anion.

19. A method according to claim 18, wherein the spray liquor is prepared using a penetrant.

20. Method according to claim 18, wherein the salt of the formula (II) is present in a concentration of from 0.75 to 37.5 mmol/l.

21. Method according to claim 19, wherein the penetrant is present in a concentration of from 0.1 to 10 g/l.

22. Method according to claim 19, wherein the penetrant is present in a concentration of from 0.1 to 10 g/l and the salt of the formula (II) is present in a concentration of from 0.75 to 37.5 mmol/l.

23. A composition of claim 1, that is capable of increasing the activity of a crop protection, said composition comprising an active compound from the class of the inhibitors of a nicotinic acetylcholine receptor and wherein, the salt of formula (II) is responsible for said increase of activity and said composition comprises a ready-to-use crop protection spray liquor.

24. A composition according to claim 23, wherein the salt of formula (II) is present in the ready-to-use crop protection spray liquor in a concentration of from 0.5 to 80 mmol/l.

25. A composition according to claim 23, wherein the ready-to-use crop protection spray liquor further comprises a penetrant.
